(19) United States
(12) Patent Application Publication
(10) Pub. No.: US 2017/0134182 A1
(43) Pub. Date: May 11, 2017

(54) Wireless Power Control, Metrics and Management

(71) Applicant: Kortek Industries Pty Ltd, Brisbane (AU)

(72) Inventors: Barrie Davis, Sanctuary Cove (AU); Benjamin Davis, Alderley (AU)

(21) Appl. No.: 15/319,706

(22) PCT Filed: May 28, 2015
(86) PCT No.: PCT/AU2015/050290

§ 371 Date: Dec. 16, 2016

(30) Foreign Application Priority Data
Jun. 20, 2014 (AU) 2014902369

(51) Int. Cl. H04L 12/28; H04W 4/00; H04W 76/02; G01D 4/00

(52) U.S. Cl. CPC H04L 12/2829; G01D 4/006; H04W 4/005; H04W 76/023; G08C 2201/93; H04Q 2209/40; H04Q 2209/60; H04W 84/12

(57) ABSTRACT

A device (200) for linking a personal controller (10) to a smartmeter (300) and a home automation device (24) which includes a wireless communications module (202) configurable to communicate with the personal controller selectively using peer-to-peer and non-peer-to-peer communications protocols. The device also includes a local network communications module (206) operable for communication with the smartmeter and the home automation device. The device is adapted to report energy usage without locally storing the energy usage data.

### FIELD OF THE INVENTION

The disclosure relates to the analysis of power metrics and control of mains power in domestic and commercial applications using standard smartphones, tablets, notebooks, laptops, netbooks, ultrabook computers and similar items to act as a communication, data processing, control and human interface for an electricity management unit and home automation products through an adaptable wireless communications link.

### BACKGROUND OF INVENTION

Power meters are a common part of domestic and commercial buildings. In recent years, there has been significant growth in technology used to measure and control mains power through the implementation of devices known as smartmeters. Smartmeters typically incorporate real-time, or near real-time, sensors that record the consumption of electricity and transfer this data remotely for monitoring and billing purposes. Smart metering is able to provide detailed metrics over time, allowing utilities to charge tiered tariffs linked to instantaneous demand and associated generation costs. With more granular measurement capabilities, it is desirable for utilities to provide a platform that allows customers to better track their electricity consumption; shed load during peak periods; and more conveniently control home and building automation devices.

In recent years, the proliferation of smartphones has placed powerful computing devices in the hands of the public. While these devices can generate and transmit wireless commands, their generic wireless systems are not compatible with the standards currently used in domestic or commercial smartmeters and a large range of home and building automation products, so they cannot natively communicate with such devices in order to exchange information or commands.

### SUMMARY

In one exemplary embodiment, the system utilizes three components: an access administrator with a wireless communications module operable for wireless communication with a personal controller and a local network communications module operable for communication with an electricity management unit and home automation devices; a battery powered personal controller able to communicate with an access administrator via a wireless communications link; and a service platform capable of exchanging data with a personal controller and access administrator. It will be appreciated that reference herein to “preferred” or “preferably” is intended as exemplary only.

Any process or mechanism used to alter the consumption of electricity by a consumer from what they would normally consume, particularly during peak periods, is typically referred to as demand response, that definition being adopted herein. An example of a demand response mechanism is the propagation of a trigger message across a power utility communications network that causes connected power control devices or appliances to power off as part of shedding load during peak consumption periods.

As used herein, the term “home automation device” or “home automation devices” includes a building automation device or devices and refers to any product, apparatus, appliance or system that can be controlled, programmed or interrogated through a wireless or wired communications link in performing a household activity or controlling part of a building's services and systems. Examples include, but are not limited to, connected or “smart”: garage door and gate mechanisms; lighting systems; lights; motorized curtains, blinds, awnings and movie screens; pool filtration systems; pumps; irrigation devices that regulate the flow of water; heating, ventilation and air-conditioning systems; thermostats; ceiling fans; security systems; sensors; hot water boilers; video and still cameras; home entertainment and musical systems; robotics; surveillance systems; door locks; appliances; whitegoods; and power control devices. Examples of power control devices are described in more detail in PCT Application No. PCT/AU2011/001666, filed Dec. 29, 2011, titled “Wireless Power, Light and Automation Control,” and PCT Application No. PCT/AU2014/001007, filed Oct. 28, 2014, titled “Adaptable Multi-Mode Wireless Power, Light and Automation”, the entire contents of each application being incorporated herein by reference. Examples of connected lighting that may be controlled by an access administrator is described in more detail in PCT Application No. PCT/AU2014/000283 filed Mar. 14, 2014, titled “Wireless Light Pairing, Dimming and Control”, the entire contents of which being incorporated herein by reference.

The access administrator is preferably configured to wirelessly operate: as an adaptable Wi-Fi Direct and network Wi-Fi device, either individually or concurrently, using Wi-Fi-Direct and/or network Wi-Fi communication technologies; and optionally as a Bluetooth device using Bluetooth SIG class 2.1+EDR or later communication technologies, including Bluetooth Low Energy, Bluetooth 4.X and meshing protocols such as CSRMesh.

As used herein, “network Wi-Fi” refers to any Wi-Fi methodology, topology, technology, protocol, standard or specification used in joining or creating a conventional infrastructure mode Wi-Fi network and includes the Wi-Fi Alliance definition as any “wireless local area network (WLAN) products that are based on the Institute of Electrical and Electronic Engineers (IEEE) 802.11 standards” including any amendments, extensions or proprietary implementations. As used herein, the term “Wi-Fi Direct” refers to a device configured to support the Wi-Fi Alliance Wi-Fi Direct specification and any amendments, extensions or proprietary implementations of Wi-Fi peer-to-peer technology. The Wi-Fi Direct specification utilizes and builds on elements of the IEEE 802.11 infrastructure mode adapted to forming peer-to-peer communications links. As used herein, the term “group participant” refers to a Wi-Fi P2P Device that can participate in a Wi-Fi P2P group as a Group Owner or P2P Client depending on the outcome of a Wi-Fi Direct negotiation, Group Owner Intent Value or configuration of a Wi-Fi Direct autonomous group. As used in this application, the term “simulating a Wi-Fi access point” refers to a device configured as a wireless infrastructure access point for the purpose of allowing a network Wi-Fi device to connect as a client in establishing a peer-to-peer communications link and may be implemented as a software enabled access point or virtual router. Through this mechanism, a peer-to-peer communications link can be established using the infrastructure mode of Wi-Fi without utilizing the Ad Hoc/Independent Basic Service Set mode of Wi-Fi.

Wi-Fi Direct and Bluetooth are peer-to-peer capable communication technologies. Peer-to-peer communication methods and control aspects that may be incorporated into the access administrator are described in more detail in PCT Application No. PCT/AU2011/001666, filed Dec. 29, 2011, titled “Wireless Power, Light and Automation Control”. Network Wi-Fi is a communication technology that allows devices to communicate through a WLAN. Adaptable network, peer-to-peer communication methods and system attributes that may be incorporated into the access administrator are described in more detail in PCT Application No. PCT/AU2014/001007 (mentioned above), and PCT Application No. PCT/AU2012/000959, filed Aug. 15, 2012, titled “Adaptable Wireless Power, Light and Automation System”, the entire contents of which is incorporated herein by reference.

In one preferred embodiment, the access administrator preferably includes a physical interface designed to accept mains level power from, and exchange data with, an electricity management unit, such as a smart meter, sub-meter or interval meter. The access administrator and electricity management unit preferably communicate by way of power line communications and include the necessary capabilities for impressing a modulated carrier signal onto mains power wiring. The supported power line communications may be by way of any protocol, standard or specification that facilitates communication between an access administrator and electricity management unit using mains power wiring. In one preferred embodiment, power line communications may incorporate one or more of: HomePlug Powerline Alliance Homeplug standards or specifications; IEEE 1901, 1901.1 and/or 1901.2 standards or specifications; and/or ITU-T's G.hn standards or specifications; including any amendments, extensions, revisions or proprietary implementations. Other suitable protocols, standards or specifications may include, but are not limited to, those from the Universal Powerline Association, SiConnect, the HD-PLC Alliance, Xsilon and Powerline Intelligent Metering Evolution Alliance. Power line communication, control methods and system attributes that may be incorporated into an access administrator are described in more detail in PCT Application No. PCT/AU2013/001157, filed Oct. 8, 2013, titled “Wireless Power Control and Metrics”, the entire disclosure of which is incorporated herein by reference. Where desirable, power line communications may be used to communicate with home automation devices.

In one preferred embodiment, in addition to, or instead of, power line communications, the access administrator may preferably include the necessary hardware and circuitry to support wireless communication with an electricity management unit and/or home automation devices via any combination of suitable personal area network (PAN) or home area network (HAN) wireless communication technologies, protocols, standards, application profiles or specifications, including one or more of: any ZigBee protocol, application profile, standard or specification published by the ZigBee Alliance; any protocol, standard or specification published by the WI-SUN Alliance; any protocol, standard or specification based on IEEE 802.15 including, but not limited to, IEEE 802.15.4; any Z-Wave protocol, standard or specification; any Thread protocol, standard or specification published by the Thread Group Alliance; and/or any protocol, standard or specification based on ANT including ANT+; including any amendments, extensions, revisions or proprietary implementations. It will be understood by those of ordinary skill in the art that a Zig Bee application profile typically defines a domain space of related applications and devices including the message types in a target application, the message formats, and the processing actions of a ZigBee device. Unless otherwise noted, the wireless local network communications capabilities will be described in terms of ZigBee, though the disclosure is not so limited and, for example, may be performed by utilizing a Z-Wave, Thread or WI-SUN protocol, standard or specification.

PAN and HAN methods and system attributes that may be incorporated into an access administrator are described in more detail in Australian Provisional Patent Application No. 2014901157, filed Mar. 31, 2014, titled “Wireless Power Metering and Metrics”, the entire disclosure of which is incorporated herein by reference.

The personal controller is preferably a commercially available mobile computing device that supports at least network Wi-Fi and may also support Wi-Fi Direct and/or Bluetooth and/or Near Field Communications (NFC). Unless otherwise noted, the personal controller will be described in terms of a smartphone, though the disclosure is not so limited. For example only, the personal controller may be a computing device which can: download or install by other means an Applications Program (App); have a suitable interface the user can interact with to control the App in order to execute required functions; have the wireless communications capability to establish a communications link with an access administrator; and have the communications capability to exchange data with a service platform. Examples of personal controllers include smartphones, tablets, laptops, smart watches, smart eye wear, ultrabooks and notebook personal computers. The functional elements of a personal controller may be performed by separate devices preferably configured to work in unison as part of a mobile computing platform, each of the component devices being a device designed for typical mobile use. By way of example, a smart watch functionally coupled to a smartphone may deliver the functional capabilities of a personal controller by operating as a unified mobile computing platform.

The access administrator can preferably form a communications link with a smartphone by using Wi-Fi Direct, simulating a Wi-Fi access point and/or utilizing a Wi-Fi network. It can be appreciated that when the access administrator is connected to a WLAN access point, a smartphone with Wi-Fi capability also connected to the same WLAN access point can use an appropriate App to communicate with the access administrator. That is, a user can enter a command into their smartphone and send it to the access administrator via the WLAN access point. In this case the smartphone could be in the vicinity of the WLAN access point, or the smartphone could be at a remote location and communicate with the WLAN access point via the Internet where the WLAN access point is so configured.

It can be appreciated that an access administrator operating in a peer-to-peer Wi-Fi mode can communicate directly with a smartphone without the requirement of a WLAN access point. In this case, the access administrator preferably simulates a Wi-Fi access point, or operates as a software access point (SoftAP), if the smartphone is not using Wi-Fi Direct to communicate; or the access administrator and smartphone can preferably negotiate which device will assume the Wi-Fi Direct group owner role and establish a peer-to-peer connection where both the smartphone and access administrator use Wi-Fi Direct to communicate. Once a peer-to-peer connection has been established, the user is able to exchange data directly between a smartphone and the selected access administrator without the need for any other intermediary or network.

The present disclosure in one preferred embodiment sets forth an access administrator with wireless communication capabilities derived from any combination and number of integrated circuits, components, controllers, transceivers, radios, memory, microprocessors, and aerials that provide simulated access point, a network Wi-Fi and Wi-Fi Direct connection, or connections, individually or concurrently. In some preferred embodiments, the access administrator may preferably include any combination and number of integrated circuits, components, controllers, transceivers, radios, memory, microprocessors, and aerials to support a wireless Bluetooth connection or connections. In some preferred embodiments, the access administrator may preferably include any combination and number of integrated circuits, components, controllers, transceivers, radios, memory, microprocessors, and aerials to support one or more wireless PAN or HAN utilizing one or more of ZigBee, Z-wave, Thread, WI-SUN, ANT or an alternate wireless network communications protocol, standard or specification. In some preferred embodiments, the access administrator may preferably include any combination and number of integrated circuits, components, controllers, transceivers, radios, memory, microprocessors, and aerials to support more than one wireless ZigBee network running simultaneously or concurrently, and where desirable, each of the simultaneous or concurrent ZigBee networks may operate using a different ZigBee application profile (or profiles), standard, specification or protocol stack. In some preferred embodiments, the access administrator may preferably include any combination and number of integrated circuits, components, controllers, transceivers, radios, memory, microprocessors, and aerials to support communications of a wireless communication protocol, standard, or specification on more than one carrier frequency, such as, and by way of example only, Zig Bee operating simultaneously or selectively on a carrier frequency of 2.4 GHz and a chosen frequency under 1 GHz, or Wi-Fi operating simultaneously or selectively on a carrier frequency of 2.4 GHz and 5 GHz.

Depending on cost and desired outcome, the wireless communication capabilities of the access administrator may be achieved by using: any number and combination of radios, aerials, transceivers, microprocessors, components, integrated circuits and controllers either individually, collectively, or as a system in a package (SiP) or as a system on a chip (SoC) or a package on package (PoP); a combination or “combo” chip that aggregates the functionality of a number of transceivers and controllers of different standards as a SiP, SoC or PoP; or using any combination and number of combo chip(s), SiP(s), SoC(s), PoP(s) and/or discrete components, integrated circuits, radios, aerials, transceivers, microprocessors and controllers. The access administrator may utilize single or multiple: wireless bands; physical channels; virtual channels; modes; or other coexistence technologies and algorithms, the methods of which are familiar to those of ordinary skill in the art and for simplicity are not described herein. Depending on the chosen hardware components, the access administrator may also include shared antenna support and shared signal receiving paths to eliminate the need for an external splitter or reduce the number of aerials required.

The present disclosure in one preferred embodiment sets forth an access administrator with adaptable wireless communications that in a first mode provides a Wi-Fi peer-to-peer connection, preferably utilizing Wi-Fi Direct or simulating a Wi-Fi access point, and in a second mode can be configured by the user to operate as a network Wi-Fi device and connect to a WLAN as a client.

The access administrator preferably has its wireless communications set to initially function in a peer-to-peer mode, preferably utilizing Wi-Fi Direct or simulating a Wi-Fi access point, irrespective of its final configuration. Because Wi-Fi Direct or simulating a Wi-Fi access point provides a peer-to-peer connection, as soon as power is applied to the access administrator, it can be recognised by a smartphone running at least network Wi-Fi and a wireless communications link can be established. A smartphone App is preferably used to configure any operational aspects and control the functional capabilities of the access administrator. Once a wireless communications link is established, the user is able to activate an App which preferably uses the data path between the smartphone and access administrator. Using an App, the user can choose if the access administrator is to continue running in peer-to-peer mode, change to network Wi-Fi mode and become a client of a Wi-Fi network, or run both modes concurrently where supported, and set the access administrator with any operational parameters required for a network Wi-Fi client or peer-to-peer Wi-Fi device such as name the device, enter a password, and any other requirements that may be required or desirable. When this procedure has been completed, the access administrator may automatically, or the user may command the access administrator to, configure itself according to the parameters which have been specified during the setup process.

If the user has chosen the access administrator to operate in a peer-to-peer mode, preferably utilizing Wi-Fi Direct or simulating a Wi-Fi access point, it would continue to do so after the access administrator configures itself according to the parameters which have been specified during the setup process. The access administrator would only connect to smartphones that can fully comply with its connection requirements before establishing a direct or peer-to-peer communications link. This may include security measures in addition to any native security measures such as Wi-Fi Protected Access or Wi-Fi Protected Access 2.

If the user has chosen the access administrator to operate in a network Wi-Fi mode as a client of a Wi-Fi network, the smartphone App would configure the necessary parameters for the access administrator to connect to a WLAN. Using those parameters, the access administrator would then connect as a client device on the WLAN. It would then preferably be accessible to devices which are also connected to the same WLAN. A peer-to-peer wireless mode of the access administrator is preferably used to configure the necessary parameters for the access administrator to connect to a WLAN as a client.

In either mode, a smartphone App is preferably used to configure and control the functional capabilities of the access administrator. In network Wi-Fi mode, the smartphone App communicates with the selected access administrator via a WLAN access point. In a peer-to-peer mode, preferably utilizing Wi-Fi Direct or simulating a Wi-Fi access point, the smartphone App communicates directly with the selected access administrator machine to machine without the use of an intermediary.

If the user has chosen the access administrator to operate in both peer-to-peer mode and network Wi-Fi mode concurrently, when the access administrator configures itself according to the parameters which have been specified during the setup process, it would appear as a client device on the WLAN and as a Wi-Fi Direct device and/or simulated Wi-Fi access point, with the functionality of each mode being available. In that way, and as an example only, an access administrator could allow third party access via a Wi-Fi Direct connection without allowing access to the concurrent WLAN connection, thus preventing access to other WLAN devices.

In one preferred embodiment, a Bluetooth peer-to-peer connection between a smartphone and access administrator may be used to enter information for configuration of the access administrator as a network Wi-Fi device and/or Wi-Fi Direct group participant and/or simulated Wi-Fi access point, or to facilitate the establishment of a network Wi-Fi and/or Wi-Fi Direct and/or peer-to-peer Wi-Fi connection. In another preferred embodiment, a Bluetooth connection between an access administrator and smartphone may be specified as a preferred peer-to-peer communication channel for the exchange of data between the App and access administrator.

Where the access administrator is configured with power line communications capabilities, once a wireless communication link is established between an access administrator and smartphone, the user is able to activate an App which preferably uses the wireless data path between the smartphone and access administrator to: configure any requirements of a power line communications network; author devices onto a power line communications network; join a power line communications network; and/or configure any requirements for the access administrator to coordinate a power line communications network. Where the access administrator is configured with wireless local network communications capabilities, once a wireless communication link is established between an access administrator and smartphone, the user is able to activate an App which preferably uses the wireless data path between the smartphone and access administrator to: configure any requirements of a wireless PAN or HAN; author devices onto a wireless PAN or HAN; join a wireless PAN or HAN; and/or configure any requirements for the access administrator to coordinate a wireless PAN or HAN.

In addition to configuring the operational aspects of the access administrator, an App would also preferably be used to do one or more of the following: process, analyse, compile, exchange, transfer, send, receive, store, manipulate, display data and/or transpose data, from, or to, an access administrator, electricity management unit and/or home automation device in any necessary way. Such data may include command, control and configuration data. Data capabilities of the App may be executed by the smartphone or may integrate an external service platform.

The service platform is preferably a cloud, applications service platform or software as a service platform that utilizes a computer(s), computing device(s) or server(s) to do one or more of the following: processing, analysing, compiling, exchanging, transferring, sending, receiving, storing, manipulating, displaying and/or transposing data, from, or to, the App, an access administrator, a home automation device, electricity management unit and/or third party. Such data may include any one or more of command, control, configuration, tariff, billing, historical, measured and trend data.

In a first preferred aspect, the disclosure sets forth a device for linking a personal controller to a smartmeter and a home automation device, the personal controller having a processor, a user interface, and a wireless communications transceiver, the smartmeter being configured to at least measure power flow. The device includes a wireless communications module operable for wireless communication with the personal controller, the wireless communications module including a radio transceiver, the wireless communications module being configured to communicate wirelessly with the personal controller in at least two different modes, a first of the modes being a peer-to-peer communications mode, a second of the modes being a non-peer-to-peer communication mode. The device also includes a local network communications module operable for communication with each of the smartmeter and with the home automation device, the local network communications module including a radio transceiver configured to operate a wireless personal area network, the local network communications module being configured to communicate with the smartmeter using a first application profile, the local network communications module being configured to communicate with the home automation device using a second application profile different from the first application profile. The device also includes a microcontroller configured to access, through the local network communications module, each of the smartmeter and the home automation device based at least in part on instructions communicated from the personal controller through the wireless communications module, the microcontroller being configured to report energy usage data without storing the energy usage data within the device.

In an additional preferred aspect, the disclosure sets forth a method for accessing, with a personal controller, a home automation device and an electricity management unit configured to at least measure power flow. The method includes receiving, at an access administrator device at or near an electricity management unit, a command from the personal controller to access at least one of the home automation device and the electricity management unit, the command being received by the access administrator device using a first communications standard; determining, with the access administrator device, whether the command sent from the personal controller is intended for the home automation device or the electricity management unit; and sending a local command, with the access administrator device, to the electricity management unit using a wireless personal area network, the local command being sent using a first application profile if the command from the personal controller is determined to be intended for the electricity management unit, otherwise sending the local command, with the access administrator device, to the home automation device using a second application profile different from the first application profile if the command from the personal controller is determined to be intended for the home automation device.

In an additional preferred aspect, the disclosure sets forth a system for controlling a network of home automation devices based on energy usage measured by a smartmeter. The system includes an access administrator including a dual-mode, wireless communications module having at least one radio configured to communicate with a smartphone, the access administrator including a local communications module including at least one ZigBee radio configured to communicate with the network of home automation devices. The system also includes a computer processor configured to operate a cloud-based platform, the processor being configured to receive data from the access administrator and/or the smartphone, the platform processor being configured to communicate data with a processor controlled by an entity without using the smartmeter as an intermediary device between the platform processor and the processor controlled by the entity.

In a further preferred aspect, the disclosure sets forth a device for linking a personal controller to a smartmeter and a home automation device, the personal controller having a processor, a user interface, and a wireless communications transceiver, the smartmeter being configured to at least measure power flow. The device includes a wireless communications module operable for wireless communication with the personal controller, the wireless communications module including a radio transceiver, the wireless communications module being configured to communicate wirelessly with the personal controller in at least two different modes, a first of the modes being a peer-to-peer communications mode, a second of the modes being a non-peer-to-peer communication mode. The device also includes a local network communications module operable for communication with each of the smartmeter and with the home automation device, the local network communications module including a radio transceiver configured to operate a wireless personal area network, the local network communications module being configured to communicate with the smartmeter using a first application profile, the local network communications module being configured to communicate with the home automation device using a second application profile different from the first application profile. The device further includes a first database configured to store usage data related to the home automation device, and a second database configured to store usage data related to the smartmeter. The device also includes a microcontroller configured to access, through the local network communications module, each of the smartmeter and the home automation device based at least in part on instructions communicated from the personal controller through the wireless communications module, the first database and the second database being independent of one another so that energy usage data stored in the first database is isolated from the energy storage data stored in the second database.

The reference to any prior art in this specification is not, and should not be taken as an acknowledgement or any form of suggestion that the prior art forms part of the common general knowledge in Australia or in any other country.

The claims as filed and attached with this specification are hereby incorporated by reference into the text of the present description.

### BRIEF DESCRIPTION OF THE DRAWINGS

FIG. 1 is a perspective view of a smartphone useable with or as part of a system and method disclosed herein.

FIG. 2 is a block diagram of the functional elements of an access administrator in accordance with a preferred embodiment of the present disclosure.

FIG. 3 is a system pictorial representation of the smartphone of FIG. 1 and its interaction with the access administrator of FIG. 2 and an electricity management unit.

FIG. 4 is a pictorial representation of the communication pathways between the smartphone of FIG. 1, the access administrator of FIG. 2, an electricity management unit and a service platform.

FIG. 4A is a pictorial representation of a local power management network in accordance with another preferred embodiment of the present disclosure.

FIG. 4B is a pictorial representation of a local power management network in accordance with a further preferred embodiment of the present disclosure.

FIG. 4C is a pictorial representation of a local power management network in accordance with an additional preferred embodiment of the present disclosure.

FIG. 5 is a block diagram of the functional elements of an access administrator in accordance with another preferred embodiment of the present disclosure.

FIG. 6 is a block diagram of the functional elements of an access administrator in accordance with another preferred embodiment of the present disclosure.

FIG. 7 is a block diagram of the functional elements of an access administrator in accordance with another preferred embodiment of the present disclosure.

FIG. 8 is a flow diagram of an exemplary configuration procedure utilizing the smartphone of FIG. 1 to configure the access administrator of FIG. 2 as a client device in Wi-Fi WLAN of FIG. 4 in accordance with one preferred embodiment of the present disclosure.

FIG. 9A is a pictorial representation of a budget tool within the Product App in accordance with a preferred embodiment of the present disclosure.

FIG. 9B is a is a pictorial representation of an information screen within the Product App in accordance with another preferred embodiment of the present disclosure.

FIG. 9C is a is a pictorial representation of an appliance measurement tool within the Product App in accordance with a further preferred embodiment of the present disclosure.

### DETAILED DESCRIPTION OF THE DRAWINGS

Alternative embodiments of the disclosure will be apparent to those of ordinary skill in the art from consideration of the specification. It is intended that the specification and examples be considered as exemplary only, with a true scope and spirit of the disclosure being indicated by the claims which follow. It will be understood that the term “comprising” is intended to have a broad, open meaning and not limited to a particular embodiment.

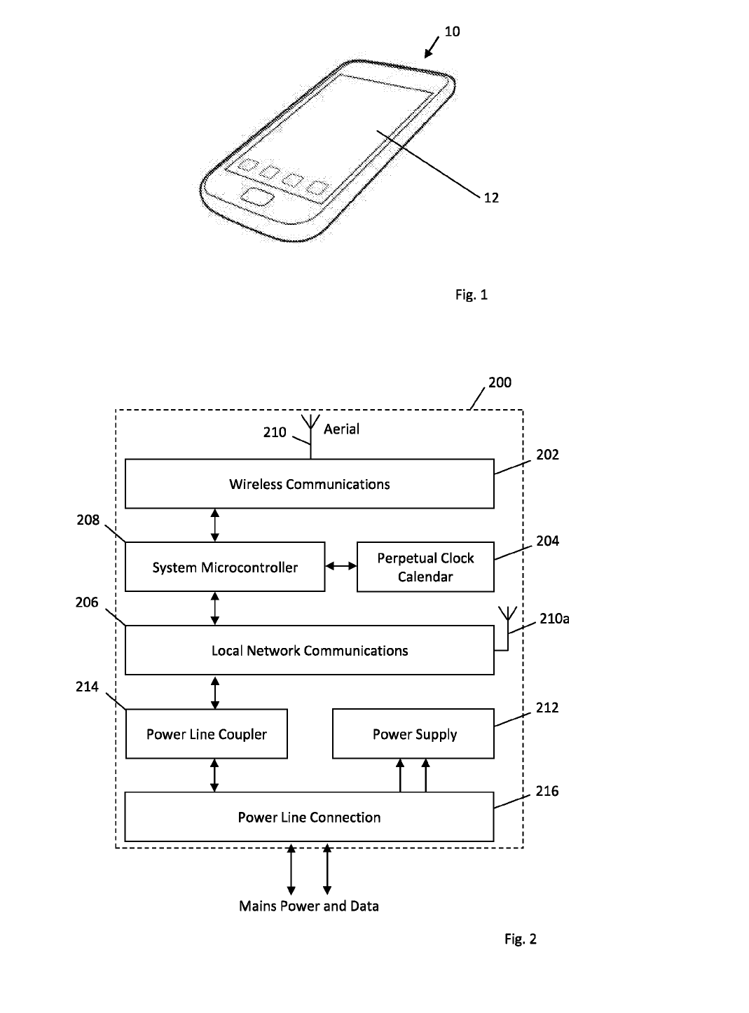

Referring to FIGS. 1 to 3, system 100 preferably includes an applications program, hereby termed a “Product App,” a personal controller 10, an access administrator 200, an electricity management unit 300 and home automation devices 24. While not shown, access administrator 200 may communicate with any number of home automation devices 24 within a home automation network utilizing the topology and methodology of a chosen shared network communication protocol, standard, or specification, up to the maximum number of home automation devices supported by the chosen communication protocol, standard, or specification, the methods of which would be understood by a person of ordinary skill in the art of network communications. It will be appreciated that more than one home automation network may operate concurrently or simultaneously in a given installation and that each home automation network may utilize different communication protocols, standards, and specifications.

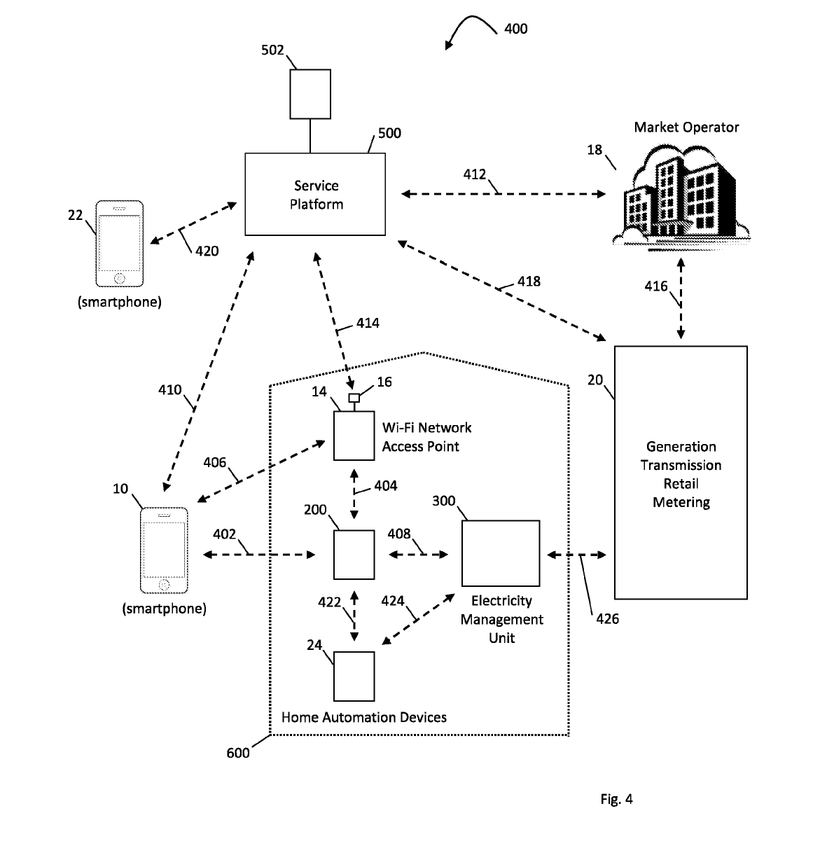

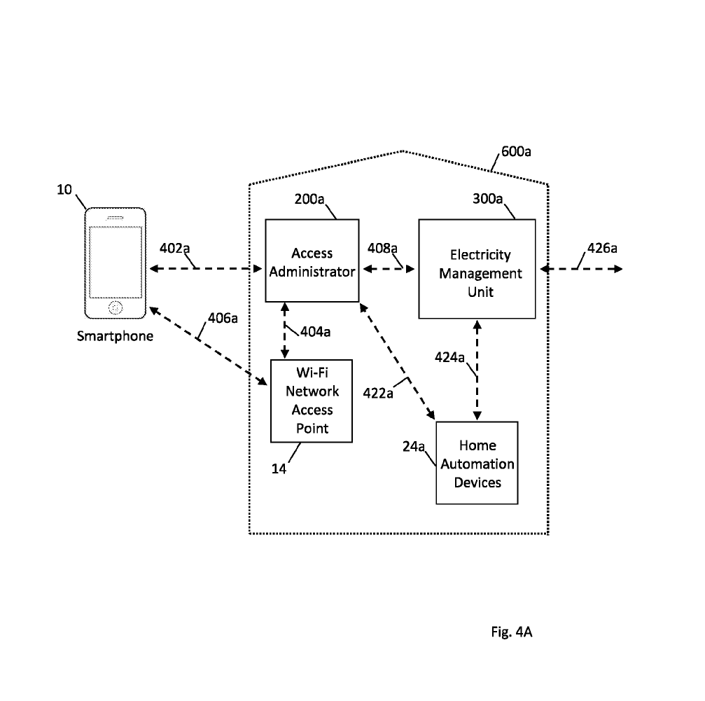

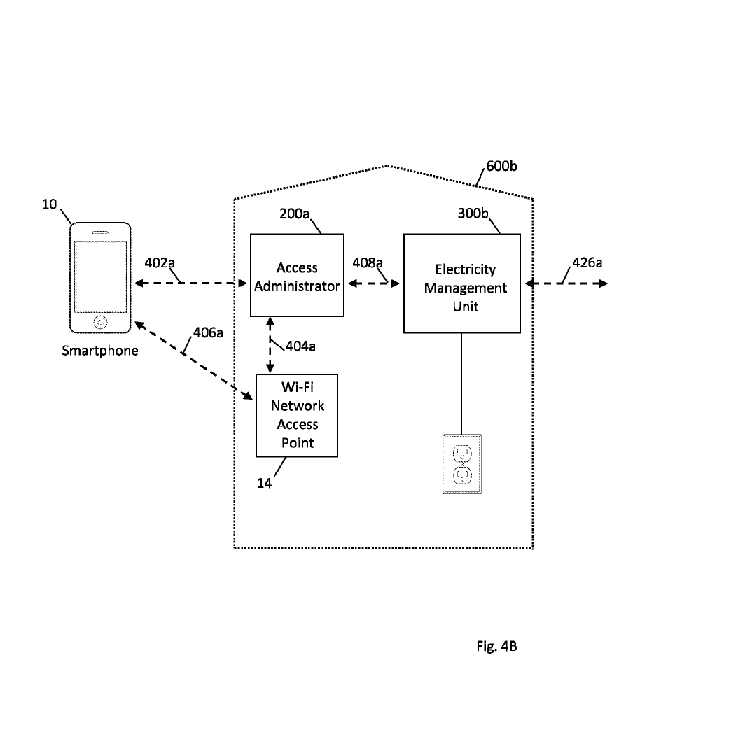

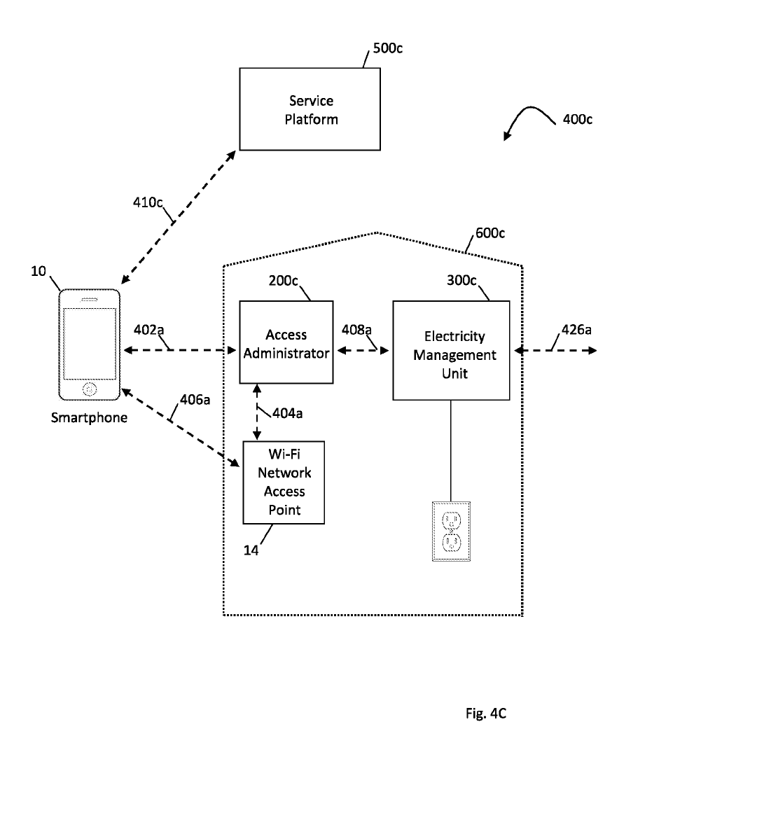

It will be understood that when needed, the Product App is typically used in combination with one or more processors, and where it is hosted, configures what might otherwise be a general purpose processor into a special purpose processor according to the functions and parameters of the Product App. Preferably, the Product App is downloaded to a computer readable medium such as a memory in smartphone 10 and operates as a human interface for the control, configuration, programming and/or interrogation of one or more of access administrator 200, electricity management unit 300 and home automation devices 24, as well as a means for processing and exchanging data with, and where desirable between, access administrator 200, electricity management unit 300, home automation devices 24 and service platform 500 (FIG. 4). The Product App may reside in or be stored on a number of different computer readable mediums such as, for example, a cloud server, and physical memories associated with computer devices, servers, and transportable storage devices and memory sticks.

System 100 may be configured to utilise combined wireless communications and power line communications in order to facilitate the exchange of data and commands. The communications between access administrator 200 and smartphone 10 preferably utilises a network WLAN, a wireless peer-to-peer connection, or both concurrently. The communications between access administrator 200 and electricity management unit 300 preferably uses power line communications or wireless PAN or HAN communications. The communications between access administrator 200 and home automation devices 24 preferably uses power line communications or wireless PAN or HAN communications. Access administrator 200 preferably draws its operational power from the same mains power lines used to exchange data with electricity management unit 300 where both the access administrator and electricity management unit are configured to communicate using power line communications. The interaction of the Product App, smartphone 10, access administrator 200, electricity management unit 300 and home automation devices 24 will be described in further detail below.

FIG. 1 is a perspective representation of a smartphone 10 which uses a wireless link to communicate with an access administrator, described in further detail below. Smartphone 10 is preferably a commercially available, conventional smartphone. Some of the basic functions the smartphone preferably includes are: a touch sensitive graphical screen interface 12; a compatible radio transceiver; and the ability to run the Product App specific to the individual smartphone operating system. In the examples that follow, specific coding for the Product App has been omitted for simplicity as a person of ordinary skill in the art would be able to understand and reproduce the functionality of the described embodiments without the need for discussion on particular coding.

Smartphone 10 is preferably configured to operate across a range of wireless communications technologies, including the technology to communicate via at least network Wi-Fi. Smartphone 10 may include additional capability for Wi-Fi Direct and/or Bluetooth and/or NFC. While preferred embodiments of the present disclosure use a smartphone as its controller, and specifically a smartphone incorporating at least network Wi-Fi capabilities, other wireless communications methods and systems could be used depending on any specific requirements.

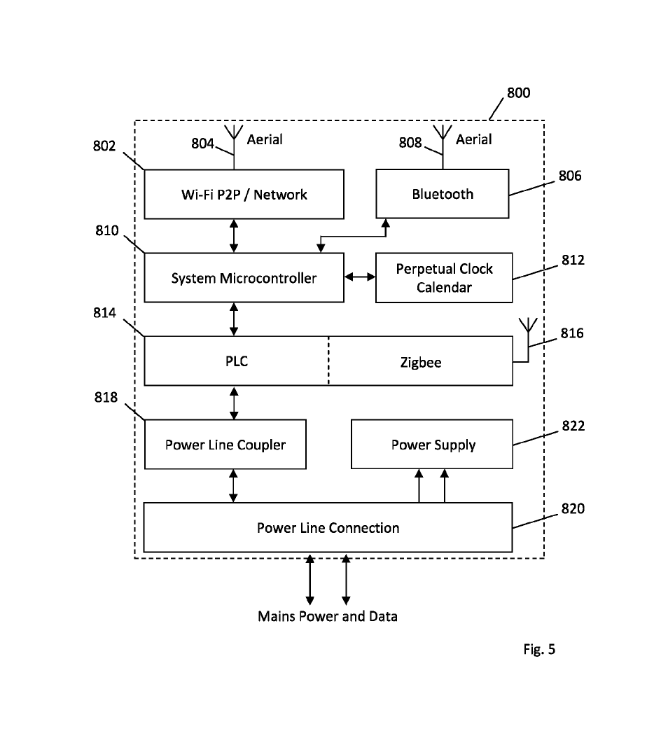

Referring now to FIG. 2, an access administrator 200 is shown in accordance with a preferred embodiment of the present disclosure. The access administrator shown in FIG. 2 generally is an overview of a preferred access administrator with additional preferred forms of the access administrator being described in reference to FIGS. 5, 6 and 7. Access administrator 200 is a physical device that preferably includes wireless communications 202, perpetual clock calendar 204, local network communications 206, system microcontroller 208 with embedded memory, an aerial 210, system power supply 212, power line coupler 214 and power line connection 216. Where local network communications 206 includes support for wireless communications, it may preferably include dedicated aerial 210a. In some preferred embodiments, it may be preferable for system microcontroller 208 to support external memory in addition to, or instead of, embedded memory. In some preferred embodiments, it may be preferable for system microcontroller 208 and local network communications 206 to be fully integrated. In some preferred embodiments, it may be preferable for system microcontroller 208 and wireless communications 202 to be fully integrated. Wireless communications 202 includes the circuitry permitting access administrator 200 to communicate with smartphone 10 and/or other system elements across one or more communications topologies and one or more communication protocols, standards, or specifications as will be described in further detail below. Local network communications 206 includes the circuitry permitting access administrator 200 to communicate with electricity management unit 300, home automation devices 24 and/or other system elements across one or more communications topologies and one or more communication protocols, standards, or specifications as will be described in further detail below.

Perpetual clock calendar 204 preferably includes a power backup by the way of a battery or supercapacitor enabling real time to be accurately maintained in instances where power is lost. Inclusion of a perpetual clock calendar 204 allows system microcontroller 208 to automatically generate commands; record data; perform a function, measurement or calculation; or exchange data, based on time and/or date. In some preferred embodiments, perpetual clock calendar 204 may be omitted where access administrator 200 does not perform any time or date dependant operations or receives clock data from an external source via power line or wireless communications. In some preferred embodiments, perpetual clock calendar 204 may be an embedded function of system microcontroller 208.

Power line connection 216 is the physical interface for connecting access administrator 200 to the mains power wiring in a building. In one preferred embodiment, power line connection 216 is preferably configured for compatibility with the NEMA 5-15 North American or BS 1363 mains power standard allowing access administrator 200 to plug directly into a mains power general purpose outlet. In one preferred embodiment, access administrator 200 may take the physical form of a fully self-contained plug in pack or “wall wart”. In another preferred embodiment, access administrator 200 may have a flying lead. In another preferred embodiment, power line connection 216 may preferably incorporate a terminal block configured for wiring directly into the mains power of a building or structure and may be configured in a wall panel, or behind a wall mounted panel, or integrated into a general purpose power outlet or light switch. It will be appreciated that access administrator 200 may be configured according to the wiring, connecting, mounting, plug and socket, and current and voltage requirements of various countries and applications without departing from the scope of the present disclosure.

The commands and responses between system microcontroller 208 and smartphone 10 are communicated through a radio frequency wireless link supported by wireless communications 202 and aerial 210. Wireless communications 202 preferably includes any number and combination of integrated circuits, components, controllers, transceivers, radios, memory, microprocessors, and aerials that provide a network Wi-Fi and Wi-Fi peer-to-peer connection, or connections, individually or concurrently, with the ability to optionally support Bluetooth. Depending on cost and desired outcome, wireless communications 202 may use any number and combination of radios, aerials, transceivers, microprocessors, components, integrated circuits and controllers either individually, collectively, or as a system in a package (SiP) or as a system on a chip (SoC) or as a package on package (PoP); a combination or “combo” chip that aggregates the functionality of a number of transceivers and controllers of different standards as a SiP or SoC; or using any combination and number of combo chip(s), SiP(s), SoC(s), PoP(s) and/or discrete integrated circuits, radios, aerials, transceivers, microprocessors, memory, components and controllers. Wireless communications may utilize single or multiple: wireless bands; physical channels; virtual channels; modes; or other coexistence technologies and algorithms, the methods of which are familiar to those of ordinary skill in the art and for simplicity are not described herein. Depending on the chosen hardware components, wireless communications 202 may also include shared antenna support and shared signal receiving paths to eliminate the need for an external splitter or reduce the number of aerials required. In one preferred embodiment, wireless communications 202 may be configured to support ZigBee. If desired, an additional aerial or aerials may be added where shared antenna support is not feasible.

Wireless communications 202 is configured with at least a Wi-Fi radio that preferably operates in a peer-to-peer mode, utilizing Wi-Fi Direct or simulating a Wi-Fi access point, and in a network Wi-Fi mode. In one preferred embodiment, wireless communications 202 configured with at least a Wi-Fi radio may preferably be capable of operating in a peer-to-peer mode, utilizing Wi-Fi Direct or simulating a Wi-Fi access point, and in a network Wi-Fi mode concurrently. Concurrent connections preferably include support for multiple MAC entities which, for example, may be maintained using two separate physical MAC entities, each associated with its own PHY entity, or using a single PHY entity encompassing two or more virtual MAC entities.

When wireless communications 202 operates using a peer-to-peer Wi-Fi specification or standard, preferably Wi-Fi Direct or simulating a Wi-Fi access point, it can communicate with smartphones that support network Wi-Fi or Wi-Fi Direct on a peer-to-peer basis without the need for any intermediary hardware. Wireless communications 202 is preferably configured to operate according to the Wi-Fi Direct specification as both a Wi-Fi Direct group participant and software access point or SoftAP, allowing access administrator 200 to simulate an infrastructure mode Wi-Fi access point and appear to smartphones communicating with network Wi-Fi as a conventional Wi-Fi access point. Through a SoftAP, wireless communications 202 is able to establish a peer-to-peer communications link with a network Wi-Fi device even though the network Wi-Fi device many not support Wi-Fi Direct. In this instance, a smartphone using network Wi-Fi to communicate will receive a network discovery message or Service Set Identifier (SSID) from access administrator 200 as if access administrator 200 were a conventional Wi-Fi access point and the smartphone will be able to establish a peer-to-peer communications link with the access administrator as though it were connecting as a client to a conventional Wi-Fi access point. In that way, smartphone 10 and access administrator 200 can form a peer-to-peer communications link using the infrastructure mode of Wi-Fi rather than Ad Hoc mode. The procedure of establishing a communications link between a Wi-Fi Direct device and network Wi-Fi devices are defined in the Wi-Fi Alliance specifications and would be understood by practitioners skilled in communications systems protocols.

Wi-Fi Direct has a number of advantages which simplify communications between an access administrator and a smartphone. Significant advantages include mobility and portability, where a smartphone and access administrator only need to be within radio range of each other to establish a wireless communications link. Wi-Fi Direct offers secure communications through means such as Wi-Fi Protected Access (WPA, WPA2) protocols and encryption for transported messages, ensuring the system remains secure to qualified devices. One of the advantages of Wi-Fi Direct is that it allows a smartphone with only network Wi-Fi to engage in a peer-to-peer data exchange with an access administrator even though the smartphone network Wi-Fi was never intended to support on-demand, peer-to-peer communications.

Another advantage of configuring an access administrator 200 with Wi-Fi Direct or having it simulate an access point is that it can be installed and used in buildings where there is no Wi-Fi network installed or available. This greatly extends the functionality of the access administrator and allows it to bridge communications between smartphones, electricity management units and home automation devices without reliance on a Wi-Fi network.

As smartphones continue to evolve, new models are starting to include Wi-Fi Direct support in addition to network Wi-Fi. In one preferred embodiment of the present disclosure, and without limiting the ability to use any other Wi-Fi Direct methods such as P2P autonomous group formation or P2P persistent group formation, access administrator 200 and smartphone 10 may utilize a P2P standard group formation method and negotiate a P2P group according to the Wi-Fi Direct specification. Access administrator 200 and smartphone 10 preferably discover each other through Wi-Fi scanning and exchange of probe requests and probe responses and then proceed to negotiate which device will assume the role of Group Owner based on declared Group Owner Intent Values in accordance with the Wi-Fi Alliance Wi-Fi Direct specification. Once a Group Owner has been agreed, it will beacon on the selected channel allowing a secure peer-to-peer communication link to be established through Wi-Fi protected setup provisioning and a Dynamic Host Configuration Protocol (DHCP) exchange to set up the internet protocol configuration.

The Wi-Fi Direct specification allows any Wi-Fi Direct device to be a Group Owner, and, depending on the capabilities of the device, the negotiation procedure determines the most suitable device to perform this role. Access administrator 200, in one preferred embodiment, may preferably be configured with the highest priority Group Owner Intent Value to negotiate a Wi-Fi Direct connection as Group Owner. By operating as Group Owner, access administrator 200 can maintain a number of simultaneous peer-to-peer connections in what is commonly referred to as a hub and spoke arrangement, although it may be desirable in some circumstances to limit the number of open connections to a 1:1 ratio.

In one preferred embodiment, access administrator 200 may be configured to autonomously create a P2P group in immediately becoming the Group Owner. Through a beacon from access administrator 200, other devices can discover the access administrator's established group using traditional Wi-Fi scanning mechanisms, and then directly proceed with Wi-Fi protected setup provisioning and address configuration to join the group as a P2P Client. In this instance there is no negotiation of the Group Owner role between the smartphone 10 and access administrator 200.

In one preferred embodiment, where an access administrator 200 and smartphone 10 have previously formed a Wi-Fi Direct communications link, access administrator 200 and/or smartphone 10 may preferably declare a group as persistent by using a flag in the P2P capabilities attribute present in beacon frames, probe responses and/or Group Owner negotiation frames. In that way, the access administrator and smartphone store network credentials and their assigned roles as a Group Owner or P2P Client for subsequent re-instantiations of the group. After the discovery phase, if access administrator 200 or smartphone 10 recognizes that they have formed a persistent group with each other in the past, either the access administered 200 or smartphone 10 can use the Wi-Fi Direct invitation procedure to quickly re-instantiate the group rather than re-negotiating which device will take on the Group Owner role.

In one preferred embodiment, it may be desirable for access administrator 200 to disclose its services as an access administrator in relation to a service discovery query at the link layer prior to establishing a P2P group. This would preferably enable the Product App or smartphone to search for and identify access administrators via advertised services and allow the Product App to ignore other peer-to-peer Wi-Fi devices prior to establishing a communications link.

In one preferred embodiment, access administrator 200 may preferably be configured to support Neighbor Awareness Networking (NAN) according to the Wi-Fi Alliance's NAN technical specifications, including architecture, technologies, methodologies, protocols, standards or specifications for interoperability amongst Wi-Fi Aware™ devices. NAN allows smartphone 10 or the Product App to discover access administrator 200 and its capabilities through small service discovery messages before making a Wi-Fi connection via Wi-Fi Direct or network Wi-Fi. In that way, smartphone 10 or the Product App may preferably search for and display only relevant access administrators and ignore other Wi-Fi devices prior to establishing a communications link. In one preferred embodiment, where access administrator 200 is configured to support NAN, it may preferably be configured as a NAN Infrastructure Device with a high Master Preference value, for example greater than or equal to 128.

In one preferred embodiment, access administrator 200 may be configured to support multiple MAC entities. Where access administrator 200 is configured to support multiple MAC entities, it may preferably operate as a NAN Concurrent Device and run concurrently in a NAN network while maintaining a separate communications link utilizing Wi-Fi Direct or network Wi-Fi.

System microcontroller 208 preferably incorporates a firmware program which defines the operation and functions of access administrator 200 and assumes responsibility for controlling program code and system elements, including: specifying and controlling the operational modes of wireless communications 202; control and interrogation of perpetual clock calendar 204; and specifying and controlling the operational modes of local network communications 206. System microcontroller 208 preferably includes non-volatile memory to store any program and configuration data, and any data received from the Product App, electricity management unit, home automation devices, or service platform. In some preferred embodiments, non-volatile memory may be external to system microcontroller 208. In some preferred embodiments, more than one microcontroller may be used.

When access administrator 200 is manufactured, system microcontroller 208 preferably holds the firmware to operate access administrator 200 as a network Wi-Fi device, Wi-Fi Direct device and a SoftAP. When power is applied to access administrator 200 for the first time, system microcontroller 208 preferably starts wireless communications 202 in a Wi-Fi peer-to-peer mode and begins transmitting discovery messages that can be detected by a smartphone within wireless range.

It can be appreciated that an access administrator operating as a Wi-Fi Direct device can communicate directly with a smartphone without needing a Wi-Fi WLAN access point. Access administrator 200 preferably appears as a Wi-Fi access point if smartphone 10 is not using Wi-Fi Direct to communicate; or negotiates with smartphone 10 as to which device will assume a Wi-Fi Direct Group Owner role if smartphone 10 is using Wi-Fi Direct to communicate. The user is then able to establish a peer-to-peer communications link and exchange data directly with the selected access administrator without the need for any other device.

In one preferred embodiment, access administrator 200 in a peer-to-peer mode may be configured to preferably simulate a Wi-Fi access point or operate as a SoftAP without support for Wi-Fi Direct. In that case, a smartphone would preferably establish a peer-to-peer communications link with an access administrator as if connecting as a client to a Wi-Fi access point, but could not negotiate with an access administrator a Wi-Fi Direct connection even if smartphone 10 supported Wi-Fi Direct.

A preferred method for configuring and controlling access administrator 200 is through a related Product App. Installation instructions for the Product App are preferably included with the access administrator. The Product App preferably adopts the same centralized app store installation methods commonly utilised by conventional smartphone platforms.

The Product App may communicate with any mix of wireless elements and radio technologies to seamlessly provide the best communications link with an access administrator. The Product App preferably controls smartphone 10 wireless communications in order to initiate, search and establish a wireless communications link with an access administrator. The Product App may preferably display preconfigured and new access administrators via graphical elements on smartphone touch screen 12.

When the Product App starts, it will preferably scan for access administrators and identify any new access administrator that needs to be initially configured. At this point, if a wireless peer-to-peer connection has not already been established between the smartphone and a new access administrator, the Product App preferably allows the user to establish a wireless peer-to-peer connection with the desired access administrator and determine if it is to: operate in peer-to-peer mode and remain a Wi-Fi Direct group participant; simulate a Wi-Fi access point; operate in network Wi-Fi mode and connect to a WLAN as a client and become a network Wi-Fi device; or, where supported by wireless communications 202, operate concurrently in a Wi-Fi peer-to-peer mode and network Wi-Fi mode.

In a situation where the smartphone operating system does not allow the Product App to control the smartphone wireless communications in order to establish a peer-to-peer link with an access administrator, the user may use any mechanism provided by the smartphone to establish a peer-to-peer communication link with an access administrator prior to starting the Product App. This could, by way of example, include accessing the smartphone Wi-Fi settings screen and manually selecting the SSID that corresponds to access administrator 200 and entering any information needed to connect to the access administrator as the desired Wi-Fi network.

If the user wants the new access administrator to run in a Wi-Fi peer-to-peer mode, preferably utilizing Wi-Fi Direct or simulating a Wi-Fi access point, they preferably select this option in the Product App. The Product App then leads the user through a series of data inputs using the smartphone's touch screen 12 as a human interface. The Product App communicates with system microcontroller 208 and replaces the general parameters used for the initial connection to specific parameters which define the access administrator as a unique product. These may include: setting a unique encryption key so all data transfers between the access administrator and the smartphone are protected; setting the access administrator name to a unique, easily recognisable identifier; and setting a password in the access administrator used to establish a secure link with a smartphone.

The Product App preferably maintains a record of these specific parameters in the smartphone memory for future identification of, and connection to, the configured access administrator.

Once the setup procedure is complete, the Product App preferably commands the access administrator firmware to reconfigure which may involve a “restart”. When the applications firmware reconfigures, the access administrator will use the specified data to populate and create its own unique identity. The smartphone which was used to set this identity will be able to automatically connect to that access administrator because the new specific parameters are known. Where the smartphone operating system allows, the Product App can then be used to preferably automatically establish a communications link with the access administrator each time the user selects that particular device in the Product App.

Once an access administrator has been configured, any other smartphone can only connect if the user knows the specific parameters that are now unique to that particular access administrator. If a second smartphone searches for Wi-Fi access points or Wi-Fi Direct devices, it will see the configured access administrator with the characteristic that it is “secure”. To connect to it, the user will have to know the specific password allocated to that access administrator, otherwise it will not be able to establish a communications link. If the password is known and entered into the smartphone when requested, a communication link between the second smartphone and the access administrator will be established. The Product App is still preferably required to control the access administrator and this may have additional security measures depending on the nature of the application.

If, instead of configuring the newly installed access administrator in peer-to-peer mode, the user chooses it to operate in network Wi-Fi mode, this is selected as the required option and the Product App determines if there are one or more WLANs available for the access administrator to connect to as a client. The Product App requests the user to confirm the preferred network and asks the user to confirm and/or input any necessary network parameters such as the network password so the access administrator can connect to the chosen WLAN as a client.

The Product App, via the smartphone, communicates with system microcontroller 208 and sets the parameters needed for the access administrator to establish itself as a network Wi-Fi device which may include any parameters that uniquely identify the access administrator on the network. When all of the appropriate parameters are known and updated, the Product App commands the access administrator to enable its firmware as a network Wi-Fi device which may involve a “restart”. The access administrator then connects to the WLAN as a client and is accessible by the smartphone Product App via the WLAN access point. The access administrator running as a network Wi-Fi client can then be controlled by other smartphones on the same WLAN. In one preferred embodiment, it may be desirable for the access administrator to include additional security measures such as password protection, a socket layer within the Product App, a hardware authorization chip, or other measures to prevent the access administrator being controlled by other devices on the network without authorization.

Access administrator preferably includes any necessary networking protocols to assist in the discovery of access administrator 200 on a network including, but not limited to, Bonjour, Simple Service Discovery Protocol (SSDP), Bluetooth® Service Discovery Protocol (SDP), DNS service discovery (DNS/DNS-SD), Dynamic Host Configuration Protocol (DHCP), Internet Storage Name Service (iSNS), Jini for Java objects, Service Location Protocol (SLP), Session Announcement Protocol (SAP) for RTP sessions, Simple Service Discovery Protocol (SSDP) for Universal Plug and Play (UPnP), Universal Description Discovery and Integration (UDDI) for web services, Web Proxy Autodiscovery protocol (WPAD), Web Services Dynamic Discovery (WS-Discovery), XMPP Service Discovery (XEP-0030), and/or XRDS for XRI, OpenID, OAuth, etc.

Preferably, where the smartphone is configured to determine from an access administrator's wireless signal, or during service discovery, that the access administrator is a new wireless device that can be configured as a WLAN network client, the smartphone or Product App preferably allows a user to automatically input the necessary network parameters of a known WLAN from the smartphone's memory into the access administrator wirelessly using a peer-to-peer communications link to automatically configure the access administrator as a network client of the known WLAN. The smartphone may also be able to determine from the access administrator's wireless signal, or during service discovery, a product identifier preferably allowing the smartphone to automatically download the access administrator's related Product App from the appropriate App store.

In one preferred embodiment, access administrator 200 may be configured to support Apple Wireless Accessory Configuration, including any related software, firmware or hardware authentication required to establish a secure peer-to-peer Wi-Fi communications link between access administrator 200 and smartphone 10 used to automatically configure access administrator 200 as a client of a known Wi-Fi network. Where desirable, access administrator 200 and the Product App may preferably be configured to support Apple HomeKit.

Once an access administrator has been configured as a Wi-Fi Direct group participant, simulated Wi-Fi access point or a network Wi-Fi device, it preferably continues to operate in that mode even after it has been powered off and then on again. All of the specific operating parameters for each mode are preferably saved in the non-volatile memory and are retained if power is removed. When power is restored, system microcontroller 208 powers up the same Wi-Fi mode that was running before power was removed, and the appropriate firmware and operating parameters are restored from non-volatile memory.

There are applications where an access administrator running concurrent Wi-Fi peer-to-peer and network Wi-Fi capabilities is desirable. In this situation, the user via the Product App may activate both modes, allowing either mode to be used. Equally, the user, via the Product App, can choose to disable one of the modes, or can change from a peer-to-peer Wi-Fi mode to network Wi-Fi mode, or vice versa, as desired. Concurrent peer-to-peer Wi-Fi and network Wi-Fi capabilities may be configured according to the desired security requirements of a particular application. By way of example, where access administrator 200 operates a network WLAN and peer-to-peer connection concurrently, access administrator 200 may allow third parties to control or access functions via the peer-to-peer connection without allowing access to the concurrent WLAN connection, thus preventing access to other WLAN devices. Alternately, access administrator 200 may allow remote monitoring of the system or data exchange via the network WLAN connection while limiting actual control of the system to a peer-to-peer connection.

Each time the Wi-Fi mode is changed, the parameters for the new mode are preferably retained by system microcontroller 208 in the event power is disconnected or lost. When power is restored, system microcontroller 208 powers up in the same Wi-Fi mode as previously operating before power was removed, and the appropriate operating parameters are restored from the non-volatile memory. In that way, system microcontroller 208 preferably is configured with an adapted default setting that can be restored from the non-volatile memory. It is envisaged that there may be times when an access administrator may need to be completely reset. The Product App is preferably able to communicate with an access administrator and command it to re-initialise to the factory default configuration. In this case, all user-defined parameters that were loaded into the access administrator are lost and it is returned to its factory default state, ready to receive new user-defined parameters.

The access administrator may incorporate a human interface in the form of a switch(s), button(s), or capacitive/proximity touch pad(s), or a sound transducer for use with voice-recognition software, which the user could use to cause the access administrator to: re-initialise to the factory default configuration without the use of a smartphone or Product App; reboot the system; or assist in a Wi-Fi Protected Setup. In one preferred embodiment, the access administrator may be configured to accept a command via local network communications 206 using a power line communications connection or a wireless ZigBee connection, causing it to re-initialise to the factory default configuration without the direct wireless use of a smartphone or Product App on the smartphone. If desired, the access administrator may be configured for operation without any manual inputs on the device itself.

In one preferred embodiment, wireless communications 202 may include Bluetooth capabilities in addition to, or instead of, peer-to-peer Wi-Fi and network Wi-Fi capabilities. A peer-to-peer Bluetooth communication link between smartphone 10 and access administrator 200 may be used by the Product App to enter parameters for establishing a peer-to-peer Wi-Fi, Wi-Fi Direct or network Wi-Fi communications link, or open a peer-to-peer Wi-Fi, Wi-Fi Direct or network Wi-Fi communications link, or may in its own right operate as a peer-to-peer communications link for the exchange of data between the Product App and access administrator 200. The Product App, the smartphone operating system, or a human interface on access administrator 200 in the form of touch pad(s), button(s), switch(s), or sound transducer(s) may facilitate the establishment of a Bluetooth peer-to-peer connection between access administrator 200 and smartphone 10. The Product App may be configured to allow a user to specify Bluetooth as the preferred peer-to-peer communication method between an access administrator 200 and smartphone 10. The Bluetooth connection preferably utilizes the secure transmission methods and protocols native to the chosen Bluetooth standard.

Where smartphone 10 and access administrator 200 use a proprietary implementation of peer-to-peer Wi-Fi or an adaptation of Wi-Fi Direct, access administrator 200 and smartphone 10 are preferably configured to use the handshake, negotiation methods, protocols, standards, specifications and configuration requirements particular to that proprietary implementation of peer-to-peer Wi-Fi or adaptation of Wi-Fi Direct, and may incorporate any hardware, software, firmware or authentication schemes necessary, and may use Bluetooth to facilitate the establishment of a peer-to-peer Wi-Fi communication link where desirable.

In a preferred form of the present disclosure, a communications link or mode utilising the ad-hoc IBSS mode of IEEE 802.11 (as commonly understood by those of ordinary skill in the art) is hereby expressly excluded.

In one preferred embodiment, the access administrator may include NFC capability that the Product App could use when first communicating with a new access administrator to automatically establish a network Wi-Fi, peer-to-peer Wi-Fi, Wi-Fi Direct, Bluetooth or other communications link on smartphones that support NFC. This process is commonly referred to as “bootstrapping” and is an established method for initializing communications familiar to those skilled in the art.

Referring back to FIG. 2, local network communications 206 preferably includes any combination and number of integrated circuits, components, controllers, transceivers, memory, microprocessors, SiPs, PoPs or SoCs that allow system microcontroller 208 to communicate with a compatible electricity management unit 300 and/or home automation devices 24 through the mains wiring of a building using any suitable power line communication protocol, standard, or specification. In one preferred embodiment, power line communications may be implemented using a single chip solution with integrated random access memory (RAM), physical layer (PHY), medium access controller (MAC), and analog front end. Local network communications 206 preferably supports one or more of: the HomePlug Powerline Alliance Homeplug standards or specifications including HomePlug Green PHY or Homeplug AV2, IEEE 1901, 1901.1, 1901.2 standards or specifications; and/or ITU-T's G.hn standards or specifications; including any amendments, extensions, subsets, revisions or proprietary implementations. Other suitable protocols, standards or specifications include, but are not limited to, those from the Universal Powerline Association, SiConnect, the HD-PLC Alliance, Xsilon, and the Powerline Intelligent Metering Evolution Alliance.

In one preferred embodiment, in addition to, or instead of, power line communications, local network communications 206 preferably includes any combination and number of integrated circuits, components, controllers, transceivers, radios, aerials, memory, microprocessors, SiPs, PoPs, or SoCs that allow system microcontroller 208 to communicate with a compatible electricity management unit 300 and/or home automation devices 24 via any suitable wireless PAN or HAN protocol, standard, application profile or specification, including one or more of: any ZigBee protocol, standard, application profile or specification published by the ZigBee Alliance; any ANT protocol, standard or specification; any protocol, standard or specification published by the WI-SUN Alliance; any Thread protocol, standard or specification published by the Thread Group Alliance; any Z-Wave protocol, standard or specification; and/or any protocol, standard or specification based on IEEE 802.15 including, but not limited to, IEEE 802.15.4; including any amendments, extensions, subsets, revisions or proprietary implementations. Where local network communications 206 is configured for wireless communications, an aerial 210a, or aerials, may be added as needed.

Local network communications 206 and/or wireless communications 202 may be configured to utilize a ZigBee Alliance Smart Energy Profile protocol, standard, application profile or specification where desirable.

In one preferred embodiment, and without limiting the ability to use any other network topologies or a particular wireless PAN or HAN protocol, standard, application profile, specification, methodology or authoring scheme, access administrator 200 may preferably be configured by the Product App to operate as a ZigBee network coordinator, router, end device, full function device, reduced function device or participant of a particular Zig Bee network. Using a wireless communication link between smartphone 10 and access administrator 200, a user via the Product App is preferably able to configure, manage and control any Zig Bee network capabilities of access administrator 200 including: joining an existing wireless ZigBee network; coordinating a wireless ZigBee network; initiating a wireless ZigBee network; or facilitating other ZigBee products in joining a ZigBee network. By way of example, access administrator 200, through the Product App, may be configured by a user to join a ZigBee Smart Energy network coordinated by an electricity management unit as a router or end device. Additionally or alternatively, access administrator 200, through the Product App, may be configured by a user to coordinate a ZigBee Home Automation network for home automation devices to join.

Because smart meters communicate across the power network through an advanced metering infrastructure that involves both personal data and data relating to the power grid, security of the network remains paramount. In one preferred embodiment, and without limiting the ability to use any other application profile, protocol, specification or standard, access administrator 200 and electricity management unit 300 are preferably configured to establish a secure communications link utilizing the trust structures and authoring methods of ZigBee Smart Energy. Electricity management unit 300 is preferably configured as the ZigBee Smart Energy coordinator and Trust Centre responsible for generation of the network key and managing the access of nodes to its Smart Energy HAN within a building, apartment or installation. Access administrator 200 is preferably configured as a ZigBee Smart Energy node and is embedded during manufacture with a link key and a Smart Energy security certificate. The link key and security certificate are preferably stored in non-volatile memory in access administrator 200.

In one preferred embodiment, access administrator 200 is assigned an installation code. The installation code preferably includes 12, 16, 24 or 32 hex digits followed by a 4-digit checksum. The leading digits are preferably used to algorithmically derive the link key stored in non-volatile memory within access administrator.

Access administrator 200 preferably has an IEEE/MAC address that corresponds to its ZigBee Smart Energy PAN or HAN. The Smart Energy IEEE/MAC address of access administrator 200 is preferably reported by microcontroller 208 or local network communications 206.

The installation code and/or Smart Energy IEEE/MAC address of access administrator 200 may be recorded on the physical unit, or in paperwork, or an electronic format such as embedded in non-volatile memory of access administrator 200 ready for automatic transfer to the Product App. The installation code and/or Smart Energy IEEE/MAC may be recorded in a visually readable from, such as QR code or barcode, allowing the Product App to utilize the smartphone camera to scan and automatically populate the Product App. It can be appreciated that a visually readable code may also contain additional information about the functional capability of access administrator 200, allowing the Product App to automatically associate and expose relevant controls for the functional capabilities during configuration. In one preferred embodiment, instead of, or in addition to a visually readable code, access administrator 200 may be configured with an NFC capability allowing for the transfer of the installation code and/or Smart Energy IEEE/MAC and any additional information to the Product App using near field communications where supported by the smartphone. The installation code and/or Smart Energy IEEE/MAC may be manually entered into the Product App.

In one preferred embodiment, electricity management unit 300 is preferably affixed with an identification code. The identification code may be recorded on the physical unit, or in paperwork. The identification code may be recorded in a visually readable from, such as QR code or barcode, allowing the Product App to utilize the smartphone camera to scan and automatically populate the Product App. It can be appreciated that a visually readable code may also contain additional information about the functional capability of electricity management unit 300, allowing the Product App to automatically associate and expose relevant controls for the functional capabilities during configuration. In one preferred embodiment, instead of, or in addition to a visually readable code, electricity management unit 300 may be configured with an NFC capability allowing for the transfer of the identification code and any additional information to the Product App using near field communications where supported by the smartphone. The identification code may be manually entered into the Product App.

In order to establish a secure communications link, access administrator 200 and electricity management unit 300 need to be placed into a secure pairing mode allowing for a multistep exchange of security keys and certificates.

In one preferred embodiment, after the initial configuration of a wireless communications link between smartphone 10 and access administrator 200, the Product App is preferably configured to interrogate access administrator 200 and determine if it has joined the network of an electricity management unit 300. If not, the Product App preferably exposes the option to begin pairing access administrator 200 with an available energy management unit 300. If a user chooses to initiate pairing, the Product App preferably automatically extracts the installation code and Smart Energy IEEE/MAC address from the non-volatile memory of access administrator 200 through a peer-to-peer or network Wi-Fi wireless communications link with access administrator 200. In order to associate access administrator 200 with the desired electricity management unit 300, the Product App is preferably configured to either visually read, or accept manual input of, the identification code of electricity management unit 300. It can be appreciated that the Product App may automatically extract the installation code and Smart Energy IEEE/MAC address from the non-volatile memory of access administrator 200 on first establishing a communications link rather than after the initiation of a pairing procedure without departing from the scope of the present disclosure.

Once the Product App has the installation code and Smart Energy IEEE/MAC address of access administrator 200 and the identification code of electricity management unit 300, the Product App preferably opens a communications channel with the user's utility or provider responsible for managing the electricity management unit's communications hub and requests that electricity management unit 300 be configured to pair with access administrator 200. The Product App preferably transfers the installation code, Smart Energy IEEE/MAC address and identification code to the utility or communications hub manager as part of this procedure. It can be appreciated that a service platform may be utilized to facilitate communications between the Product App and utility or communications hub manager without departing from the scope of the present disclosure.

In one preferred embodiment, access administrator's security certificate, or information derived from access administrator's security certificate, may preferably be automatically extracted by the Product App from access administrator 200 and transferred to a utility or communications hub manager as part of the pairing request procedure.

Upon receipt of the pairing request, a utility or communications hub manager preferably utilizes the identification code to identify and address the target electricity management unit 300 on the advanced metering infrastructure or smart energy wide area network. Utilizing the installation code, the utility or communications hub manager preferably algorithmically derives the pre-configured link key associated with, and stored within, access administrator 200. Using the advanced metering infrastructure or smart energy wide area network to communicate with electricity management unit 300, the utility or communications hub manager preferably installs access administrator's link key and Smart Energy IEEE/MAC address into electricity management unit 300 and puts electricity management unit 300 into pairing mode. The utility or communications hub manager may transfer the security certificate, or information derived from the security certificate, or a key associated with the security certificate, to utility management unit 300 as required.

In one preferred embodiment, the Product App may automatically direct microcontroller 208 to put a ZigBee Smart Energy PAN or HAN of local network communications 206 into pairing mode after sending a pairing request to a utility or communications hub manager. In one preferred embodiment, the Product App may be configured to receive a notification from a utility or communications hub manager that the user should put access administrator 200 into pairing mode for connection to their electricity management unit 300, the Product App preferably exposing a user interface that can be used to cause the Product App to direct microcontroller 208, utilizing any available communications channel between smartphone 10 and access administrator 200, to put a ZigBee Smart Energy PAN or HAN of local network communications 206 into pairing mode.

During pairing, access administrator 200 preferably transmits a joining request to electricity management unit 300 on the ZigBee Smart Energy network coordinated by electricity management unit 300. Electricity management unit 300 preferably utilizes access administrator's link key, and where necessary Smart Energy IEEE/MAC address, to provide access administrator 200 with a network key encrypted using access administrator's link key. Access administrator 200 preferably utilizes the network key to encrypt a sequence of communications with electricity management unit 300 to generate an application link key, the process of which may include an exchange of security certificates. The application link key can then be used to encrypt communications between access administrator 200 and electricity management unit 300, with access administrator having then joined the ZigBee Smart Energy network of electricity management unit 300.

Where access administrator 200 participates in a ZigBee Smart Energy network coordinated by electricity management unit 300, access administrator 200 is preferably able to communicate with other devices on the ZigBee Smart Energy network allowing the Product App to exchange data with devices other than electricity management unit 300. By way of example, access administrator 200 may preferably communicate with a gas meter configured as node of electricity management unit 300 in a dual-fuel meter arrangement such as under the United Kingdom Department of Energy & Climate Change Smart Metering Equipment Technical Specification.

In one preferred embodiment, in addition to, or instead of using a Product App, the ZigBee networking of an access administrator, electricity management unit or home automation devices may preferably make use of any mechanism available in the chosen ZigBee wireless protocol, standard, application profile or specification for initiating, joining or coordinating a network. By way of example, a human interface such as a switch, button or touch pad on a home automation device 24 and/or access administrator 200 and/or electricity management unit 300 could be used to initiate a pairing mode for the exchange of any security, trust, or networking credentials required for access administrator to join a Zig Bee network coordinated by an electricity management unit, or home automation devices to join a ZigBee network coordinated by the access administrator, the methods of which would be understood by those of ordinary skill in the art.

It is understood that some ZigBee networks operate without a coordinator. The authoring of access administrator, an electricity management unit or home automation devices onto a coordinator-less ZigBee network may preferably make use of any mechanism available in the chosen ZigBee wireless protocol, standard, application profile or specification for joining a coordinator-less network. By way of example, an access administrator may initiate or be added to a ZigBee Light Link network using the ZigBee Touchlink configuration mechanism, the methods of which would be understood by those of ordinary skill in the art. In one preferred embodiment, a ZigBee Touchlink configuration of access administrator 200 may be managed through the Product App.

The organic growth of ZigBee over a number of years has resulted in the adoption and development of a number of different ZigBee standards, application profiles, and specifications to meet the needs of particular industries. By way of example, ZigBee Smart Energy has evolved into a specific implementation of ZigBee for the utility industry with a level of complexity and number of security and trust structures not particularly suited to simple home automation. For that reason, specific implementations of ZigBee have developed for home automation, such as ZigBee Home Automation and ZigBee Light Link. It can therefore be appreciated that it may be highly desirable for an access administrator to participate in more than one ZigBee network simultaneously or concurrently in order to maximize the access administrator's capabilities and interoperability with home automation devices and smartmeters.

In one preferred embodiment, local network communications 206 may be configured to operate more than one wireless ZigBee network simultaneously or concurrently, with each ZigBee network preferably capable of communicating using a different ZigBee standard, application profile, specification, topology or access scheme where desirable. Suitable standards, application profiles, or specifications may include: ZigBee Home Automation; ZigBee Light Link; ZigBee Smart Energy; ZigBee RF4CE; ZigBee IP; ZigBee Pro; ZigBee 2.X; ZigBee 3.X or later; IEEE 802.15.4; or proprietary implementations. It will be understood by those of ordinary skill in the art that a ZigBee network can be configured with more than one application profile.

In one preferred embodiment, where local network communications 206 includes support for ZigBee, and it is desirable for access administrator to participate in two ZigBee networks at the same time, local network communications 206 may preferably be configured with a dual-network capable SoC, PoP or SiP having a single IEEE 802.15.4 radio configured to participate in two ZigBee networks by maintaining two sets of network parameters operated through manual or automatic switching modes. A dual-network capable SoC, PoP or SiP preferably includes synchronization between networks optimized for co-existence. Access administrator 200 is preferably able to operate as a ZigBee coordinator, router, end device or participant on each network depending on the desired topology of the network. By way of example, access administrator 200 could be configured through the Product App to participate in a ZigBee Smart Energy network coordinated by an electricity management unit as a router or end device, while at the same time configured to coordinate a ZigBee Home Automation network for the purpose of controlling attached home automation devices through instructions from the Product App. It can be appreciated that this allows the security and integrity of a ZigBee Smart Energy network coordinated by an electricity management unit to be maintained at a high level, while allowing the Product App to control general home automation devices on a separate network through the access administrator operating as a coordinator of a ZigBee Home Automation network.

In one preferred embodiment, and without limiting any communication paths afforded by the mix of wireless and wired communications technologies configured in an access administrator, where access administrator 200 is configured with dual-network Zig Bee communications, local network communications 206 or system microcontroller 208 may preferably transpose, route or otherwise facilitate the migration of control, command, configuration and other data between ZigBee networks. In that way, and by way of example only, a demand response signal or tariff variation from electricity management unit 300 propagated onto a ZigBee Smart Energy network in which access administrator 200 is a participant, could be propagated by access administrator 200 onto a ZigBee Home Automation network in which access administrator 200 is also a participant, allowing home automation devices to respond to the demand response signal or tariff variation in a particular way, such as turning off power to the device. By way of another example, access administrator 200 could receive a demand response signal or tariff variation on a ZigBee Smart Energy network and issue a command to a home automation device or devices on a Zig Bee Home Automation network causing a desired response.

In one preferred embodiment, where access administrator 200 is configured with dual-network ZigBee communications, each ZigBee PAN may preferably be isolated from the other and not allow data to route internally between the ZigBee PANs within access administrator 200. In that way, and by way of example only, access administrator 200 participating in a ZigBee Home Automation network and a ZigBee Smart Energy network with electricity management unit 300, may preferably not internally route, transpose or migrate data (such as a demand response signal) from electricity management unit 300 onto the ZigBee Home Automation network. By way of another example, access administrator 200 participating in a ZigBee Smart Energy network with electricity management unit 300 and a ZigBee Home Automation network may preferably not internally route, transpose or migrate data generated by a home automation device onto the ZigBee Smart Energy network such as device identifiers, status, and state data. Through this mechanism, access administrator 200 may be configured to operate discretely as a home automation hub through one PAN and a consumer access device through the other PAN, allowing users to build and maintain a home automation environment independently from their electricity billing and utility services and not having the security or trust measures of one PAN affecting the other. While it may be preferable in some embodiments not to route data between ZigBee PANs internally within access administrator 200, this should not be taken to limit the possibility of data being received by access administrator 200 on one ZigBee network, sending that data to a service platform, receiving data back from the service platform and routing, transposing or migrating that data onto the other ZigBee network where desirable.

In one preferred embodiment, access administrator 200 may be configured as an end device or reduced function device without router capabilities on a ZigBee Smart Energy network. It can be appreciated that a dual-network ZigBee architecture may be enabled in access administrator by means other than a single IEEE 802.15.4 radio, dual-network capable SoC, PoP or SiP without departing from the scope of the present disclosure. In one preferred embodiment, a dual-network ZigBee communications architecture may preferably be configured using two single radio SiPs, PoPs or SoCs, each configured to individually run a different ZigBee network under the control of a master microcontroller, such as system microcontroller 208. In another preferred embodiment, a dual-network ZigBee communications architecture may preferably be configured using a microcontroller configured to operate two separate radios through a communication interface. In another preferred embodiment, a dual-network ZigBee communications architecture may preferably be configured using a SiP, PoP or SoC and single IEEE 802.15.4 radio with a microcontroller configured to operate two networks simultaneously or concurrently in software. It will be appreciated that these are merely examples and not intended to limit the implementation of a dual-network ZigBee architecture in access administrator 200, which may utilize any suitable means and technologies available.

The ZigBee standards and specifications define a comprehensive security architecture and trust management model, which includes encryption, authentication and integrity at each layer of the ZigBee protocol stack, any element of which may preferably be utilized for ZigBee communications between an access administrator, electricity management unit and home automation devices where desirable.

Where local network communications module 206 includes support for both power line communications and wireless HAN or PAN communications, system microcontroller 208 or a dedicated microcontroller in local network communications 206 may communicate through the power line network and a wireless HAN or PAN simultaneously, or dynamically assess the most robust communication channel with an electricity management unit and/or home automation device and use the most robust communication medium in forming a communications link, or transferring data down an open communications link. The dynamic assessment may be facilitated by the use of strength of signal indicators as described in more detail below.

Because power line communications can travel outside a user's building via the mains power wiring, access administrator 200 preferably supports encryption for communications with an electricity management unit 300. Access administrator 200 and electricity management unit 300 preferably adopt the methodology and mechanisms for security and encryption of data including any passwords, security keys or other secure linking methods that are native to the chosen power line communication protocol, standard or specification.

In one preferred embodiment, and without limiting the ability to use any other pairing techniques or topology of a particular power line communication protocol, standard or specification, where electricity management unit 300 and access administrator 200 communicate using a HomePlug Powerline protocol, standard, or specification, access administrator 200 may preferably ship as an un-associated station and go into a power-on network discovery procedure broadcasting an un-associated identifier message and determining if a Homeplug network is active and can be joined on the mains power wiring of a building.

In order for access administrator 200 to join a secure power line network coordinated by electricity management unit 300, access administrator 200 preferably first obtains the network membership key of electricity management unit 300. In order to obtain the network membership key, the access administrator is preferably programmed with a unique device access key. An electricity retailer, electricity utility or manager of electricity management unit 300 preferably enters the unique device access key of access administrator 200 into electricity management unit 300 either locally or by way of an available communication pathway, such as communication pathway 426 outlined in FIG. 4, and puts electricity management unit 300 into pairing mode. Electricity management unit 300 uses the device access key to encrypt its network membership key and broadcast this over the power line network. Since the device access key is unique to access administrator 200, it will be the only new station capable of decrypting the broadcast message from electricity management unit 300 in order to retrieve the network membership key. Once access administrator 200 retrieves the network membership key, it can use this to join the power line network coordinated by electricity management unit 300. At that point, electricity management unit 300 preferably shares with access administrator 200 a network encryption key ensuring all communication between electricity management unit 300 and access administrator 200 are encrypted and secure.

The device access key of access administrator 200 may be recorded on the physical unit, or in paperwork, or an electronic format such as embedded in the memory of access administrator 200 ready for automatic transfer to the Product App. The device access key may be recorded in a visually readable from, such as QR code or barcode, allowing the Product App to utilize the smartphone camera to scan and automatically populate the Product App with the device access key. It can be appreciated that a visually readable code may also contain additional information about the functional capability of access administrator 200, allowing the Product App to automatically associate and expose relevant controls for the functional capabilities of the access administrator during configuration. In one preferred embodiment, instead of, or in addition to a visually readable code, access administrator 200 may be configured with an NFC capability allowing for the transfer of the device access key and any additional information to the Product App using near field communications where supported by the smartphone. The device access key may be manually entered into the Product App.

In another preferred embodiment, where access administrator 200 and electricity management unit 300 communicate using a HomePlug Powerline protocol, standard or specification, a secure communication pathway between electricity management unit 300 and access administrator 200 may preferably be formed by entering a network membership key of the electricity management unit into access administrator 200 via the Product App utilizing a wireless communications link between access administrator 200 and smartphone 10, thereby configuring access administrator 200 and electricity management unit 300 with the same network membership key and allowing them to form a secure network. The network membership key may be recorded on electricity management unit 300, or in paperwork or an electronic format associated with electricity management unit 300. In one preferred embodiment, the network membership key may be obtained by preferably entering a serial number such as the serial number of an electricity management unit 300 into the Product App, the Product App then accessing a service platform using the smartphone's native cellular or network Wi-Fi capabilities, and exchanging the serial number for the network membership key assigned to electricity management unit 300 identified by the serial number, which Product App could then preferably automatically load into access administrator 200. A serial number could alternately be a password, customer identification or account number, or any suitable code used to uniquely identify electricity management unit 300 on a service platform and download its associated network membership key to the Product App.

It can be appreciated that other methods of authoring an access administrator onto a power line network coordinated by electricity management unit 300 can be used without departing from the scope of the present disclosure, including methods that may use a human interface such as software or hardware buttons. By way of example only, an asymmetric public/private key encryption method could be utilized by pressing a software button in the Product App while smartphone 10 is wirelessly connected to access administrator 200 and pressing a hardware button on electricity management unit 300, the methods of which would be understood by those of ordinary skill in the art. If desired, access administrator 200 may include a button, switch or touch pad that could be used to put access administrator 200 into a secure pairing mode for the purpose of establishing a secure power line communications link with electricity management unit 300.

In one preferred embodiment, access administrator 200 and electricity management unit 300 may be provided together as a matched set or kit with all networking requirements already preconfigured. For example, the networking membership key and any other necessary networking requirements of electricity management unit 300 may be entered by the vendor or manufacturer into access administrator 200, thereby pre-configuring access administrator 200 as an associated station, router or end device of electricity management unit 300 and able to establish a secure network communications link as soon as being powered on.

Access administrator 200 and electricity management unit 300 may preferably adopt any native security measures and authoring methodologies of a desirable power line communications protocol, specification or standard. Additional security measures to any native security measures, such as security certificates, may be utilized without departing from the scope of the present invention.

A secure network between access administrator 200 and electricity management unit 300 may be limited to access administrator 200 and electricity management unit 300 if desired, thereby forming a private secure network or dedicated peer-to-peer communication pathway. A software, firmware or hardware layer in access administrator 200 and electricity management unit 300 may be included to provide an additional security service preventing other devices from communicating with access administrator 200 or electricity management unit 300 even if on the same physical layer using the same network membership key or security credentials.

In one preferred embodiment, access administrator 200 may preferably be configured as the power line communications network coordinator instead of electricity management unit 300. In one preferred embodiment, it may be desirable for the user to configure, through the Product App, which of access administrator 200 or electricity management unit 300 is to be the network coordinator according to the user's preferred topology.

While the application and formation of a secure power line communications network has been described primarily between access administrator 200 and electricity management unit 300, it will be appreciated that the power line communications network is not so limited and may be applied to the formation of a secure communications network between access administrator and home automation devices 24 for the purpose of allowing communications between the Product App and one or more home automation devices. The pairing mechanisms disclosed in relation to access administrator 200 and electricity management unit 300 may be applied to access administrator 200 and home automation devices 24.

Referring to FIG. 2, data is physically modulated onto the mains wiring preferably through power line coupler 214 which preferably includes any necessary isolation or filters.

Access administrator 200 may be configured to include one or more illumination means or visual elements that represent a status or operative element of access administrator 200. A visual element could be by way of simple light emitting diodes, LCD, colour LCD, an integrated display, or any combination thereof.

Because access administrator 200 is preferably configured with a number of radios in very close proximity operating in the 2.4 Ghz industrial, scientific and medical radio spectrum, there is a requirement to prevent radio transmissions interfering with each other. In order to prevent the communications from one radio interfering with others, system microcontroller 208 is preferably configured to sequence radio transmissions to minimize the potential for disruption. The sequencing of radio transmissions may be in addition to other coexistence methods such as dynamic frequency hopping and error correction.

It will be appreciated by those of ordinary skill in the art that the system described above can be varied in many ways without departing from the scope of the present disclosure. By way of example only, elements of wireless communications 202, system microcontroller 208, perpetual clock calendar 204 and local network communications 206 may be aggregated, or separated, into single or multiple components, SoCs, PoPs or SiPs. For example only, ZigBee may be added to wireless communications 202 instead of local network communications 206, and operate individually, concurrently, or completely replace, power line communications. If desired, power line communications and ZigBee wireless communications may be aggregated into a single SoC, PoP or SiP. Where wireless communications 202 is configured to support HAN or PAN communications, an additional aerial or aerials may be added where shared antenna support is not feasible. More than one PAN or HAN protocol, standard, application profile or specification may be integrated into local network communications 206 preferably allowing the Product App to communicate with a range of home automation devices across different PAN or HAN topologies, protocols, standards, application profiles or specifications. It will be appreciated that while Bluetooth has been discussed in relation to communications between smartphone 10 and access administrator 200, it is not so limited, and is capable of supporting short range wireless PANs with other Bluetooth enabled devices. In one preferred embodiment, Bluetooth can be used as a communication medium between access administrator 200 and Bluetooth enabled home automation devices where desirable.

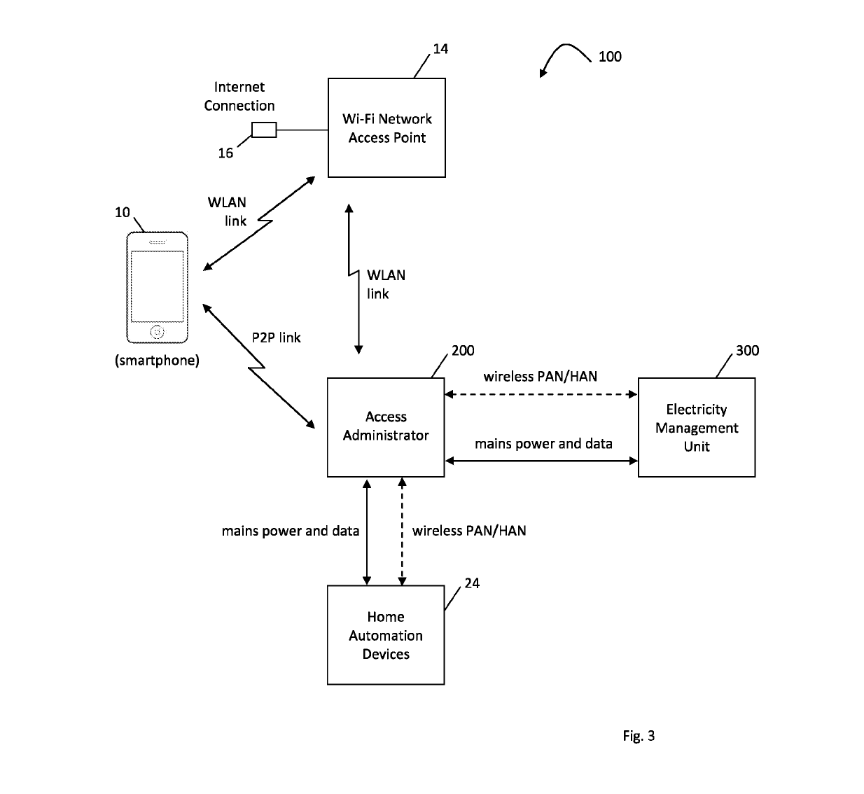

Referring now to FIG. 3, a pictorial representation of system 100 is shown with an exemplary arrangement of smartphone 10, access administrator 200, electricity management unit 300, home automation devices 24 and preferred communications systems connecting each of the elements. System microcontroller 208 (FIG. 2) is preferably configured to route, transfer or transpose data across any communications systems incorporated into access administrator 200.

Electricity management unit 300 is preferably configured to monitor electrical flow and usage. Electrical management unit 300 may be, for example only, a smart meter, sub-meter or interval meter. The Wi-Fi WLAN has an access point 14. Access point 14 has an Internet connection 16. Wi-Fi WLAN communications preferably pass through access point 14. Where access administrator 200 is configured as a network Wi-Fi device, it preferably operates as a client of access point 14. For smartphone 10 to communicate with access administrator 200 running as a network Wi-Fi client, smartphone 10 is also preferably connected to access point 14 as a client. Messages from smartphone 10 could then pass through access point 14 to access administrator 200. If smartphone 10 were not in wireless range of access point 14, it may still be able to communicate with access point 14 via internet connection 16 if so configured. The communications between a smartphone and an access point through an Internet connection will be described in further detail below.

In addition to, or instead of, operating as a network Wi-Fi device, access administrator 200 may be configured as a Wi-Fi Direct group participant or to simulate a Wi-Fi access point. In that instance, smartphone 10 can wirelessly connect directly to access administrator 200 peer-to-peer without requiring any other device. Accordingly, it can be seen that: (1) access point 14 is not required for peer-to-peer communications; (2) the communications link is formed on an “as needed” basis; and (3) that smartphone 10 needs to be within radio range of access administrator 200 to establish a direct communications link. Where desirable, a peer-to-peer connection between smartphone 10 and access administrator 200 could be established using Bluetooth.

It can be appreciated that the adaptable nature of wireless communications 202 and its multi-mode, peer-to-peer and network communications capabilities allow access administrator 200 to be configured in a number of different ways for communications with a smartphone with, or without, the use of a Wi-Fi network. An access administrator operating as a network Wi-Fi device may be remotely accessed and controlled by a smartphone where the access point has an internet connection, however the access administrator then becomes exposed to the outside world and may be vulnerable to external threats such as hacking. Alternatively, a peer-to-peer connection by virtue of its limited wireless range and architecture offers a higher level of security. The balance between operational modes is usually subjective and dependant on the application at hand. In some instances infrastructure limitations such as the availability of an access point 14 may constrain operational modes. In some markets the penetration of Wi-Fi networks is relatively low so that it is highly advantageous for access administrator 200 to provide a peer-to-peer means of communicating with a smartphone and preferably connect to a WLAN as a client if available and desirable to do so.

Access administrator 200 may be configured to measure and provide a received signal strength indicator, or received channel power indicator, of access point 14 which access administrator 200 may preferably report to the Product App for display on smartphone screen 12. A received signal strength indicator, or received channel power indicator, is a measurement of the power present in a received radio signal and allows a user to locate wireless products such as access administrator 200 close enough to access point 14 in order to ensure that a sufficiently strong wireless signal exists between the two devices to provide the best environment for a stable and reliable communications link. The Product App may also preferably display on smartphone screen 12 a received signal strength indicator, or received channel power indicator, for access administrator 200 measured by smartphone 10. The Product App may display on smartphone screen 12 a received signal strength indicator, or equivalent, of a ZigBee wireless signal from electricity management unit 300, or home automation devices 24, measured by access administrator 200.

If desired, access administrator 200 may be configured with a visual indicator capable of displaying a received signal strength indication for any wired or wireless signal that access administrator 200 may be capable of measuring.

In one preferred embodiment, the Product App may preferably display a signal strength indicator, or received channel power indicator, of access point 14 as measured by smartphone 10 in order to assist with the initial placement and installation of access administrator 200 before it has been powered on and any communications links have been established. In that way, a user through the Product App could preferably stand in close proximity to the location where they wished to install access administrator 200 and through the Product App utilizing a smartphone's wireless communications, take a signal strength or received channel power measurement of access point 14 and displaying that in the Product App, thereby allowing the Product App or user to determine if a sufficiently strong wireless signal exists to optimally support access administrator operating as a client of access point 14 at that proximate location. In one preferred embodiment, the Product App may provide a visual indicator that identifies the suitability of the measured signal strength of access point 14 in supporting access administrator 200 as a client. By way of example, this could include a pointer or indicator against coloured sections within the Product App, the coloured sections preferably comprising red, orange and green with red denoting a poor measured signal strength of access point 14 and therefore an unsuitable proximate location to install the access administrator, orange denoting an acceptable but not optimum location, and green denoting a strong measured signal strength of access point 14 and therefore a suitable proximate location for installation of the access administrator. It can be appreciated that other visual indicators may be suitable and within scope of the present disclosure where they preferably identify the suitability of a proximate location for an access administrator 200 based on the measured signal strength of an access point 14 by smartphone 10.

Referring again to FIG. 3, access administrator 200 preferably derives its power and communicates with electricity management unit 300 through mains power lines using power line communications where both access administrator 200 and electricity management unit 300 are configured with power line communications. It can be appreciated that power line communications allow for the convenient placement of an access administrator within a building's mains power architecture. Access administrator 200 may also preferably communicate with home automation devices 24 through mains power lines using power line communications where the home automation devices are so configured. In one preferred embodiment, access administrator 200 may communicate with home automation devices 24 using power line communications and not electricity management unit 300 where electricity management unit 300 is not configured with power line communications or it is desirable not to use power line communications between access administrator 200 and electricity management unit 300 even where both are configured to support power line communications.

Access administrator 200 may be configured to communicate with electricity management unit 300 wirelessly using ZigBee instead of, or additional to, using power line communications. Where access administrator 200 is configured with the ability to communicate using ZigBee and power line communications, and electricity management unit 300 supports both ZigBee and power line communications, access administrator 200 is preferably configured with the ability to dynamically assess the most robust communication channel with electricity management unit 300 and use the most robust communication medium in forming a communications link or transferring data down open communication links. In one preferred embodiment, where access administrator 200 is configured with the ability to communicate using ZigBee and power line communications, and electricity management unit 300 supports both ZigBee and power line communications, a user through the Product App may configure access administrator 200 to communicate with electricity management unit 300 only using ZigBee or only using power line communications.

Access administrator 200 may be configured to communicate with home automation devices 24 wirelessly using ZigBee instead of, or additional to, using power line communications. Where access administrator 200 is configured with the ability to communicate using ZigBee and power line communications, and a home automation device supports both ZigBee and power line communications, access administrator 200 is preferably configured with the ability to dynamically assess the most robust communication channel with a home automation device and use the most robust communication medium in forming a communications link or transferring data down open communication links. In one preferred embodiment, where access administrator 200 is configured with the ability to communicate using ZigBee and power line communications, and a home automation device supports both ZigBee and power line communications, a user through the Product App may configure access administrator 200 to communicate with a home automation device only using ZigBee or only using power line communications.

In one preferred embodiment, access administrator 200 may be configured with ZigBee wireless communications and no power line communications for use in installations where electricity management unit 300 and home automation devices 24 are configured to utilize ZigBee and do not support power line communications.

Where access administrator 200, electricity management unit 300 and home automation devices 24 are each configured with local network communications that utilize ZigBee, it may be preferable to configure access administrator 200 with dual-network Zig Bee communication capabilities allowing it to participate in a dedicated ZigBee network for communication with electricity management unit 300 and a dedicated ZigBee network for communicating with home automation devices 24, the methodology of which has been outlined earlier in relation to FIG. 2.

Because smartphones do not typically include native power line or ZigBee communication capabilities, they cannot communicate directly with an electricity management unit 300 or home automation devices 24 configured with power line or ZigBee communication capabilities. Access administrator 200 therefore preferably performs any computational tasks necessary to ensure data from the Product App is transposed into a format compatible with electricity management unit 300 or home automation devices 24, and data from electricity management unit 300 or home automation devices 24 is transposed into a format compatible with the Product App, thereby facilitating two way communications between the Product App and electricity management unit 300 or home automation devices 24, through access administrator 200 as shown in FIG. 3.

In order for the Product App running on smartphone 10 and electricity management unit 300 to communicate, any data preferably passes between access administrator 200 and smartphone 10 wirelessly either peer-to-peer or via access point 14, depending on the chosen configuration of access administrator 200. Any data passing between access administrator 200 and electricity management unit 300 preferably does so through a building's mains power wiring using power line communications, or wirelessly using ZigBee depending on the configuration of electricity management unit and access administrator 200.

In order for the Product App running on smartphone 10 and home automation devices 24 to communicate, any data preferably passes between access administrator 200 and smartphone 10 wirelessly either peer-to-peer or via access point 14, depending on the chosen configuration of access administrator 200. Any data passing between access administrator 200 and home automation devices 24 preferably does so over a building's mains power wiring using power line communications, or wirelessly using ZigBee, depending on the configuration of the home automation device and access administrator 200. The Product App is preferably configured to expose or cause the display of the controls and capabilities of a home automation device that is part of a home automation network to which access administrator is a participant or coordinator, allowing the Product App running on smartphone 10 to exchange data and commands with a desired home automation product through access administrator 200 acting as an intermediary and facilitator. Some home automation devices may utilize their own proprietary command sets or language even where using an open communication protocol, standard or specification, in which case the Product App is preferably configured to utilize the proprietary command sets or language of the target home automation device in order to effectively exchange commands and data. In one preferred embodiment, the Product App may be configured with a range of different command sets or languages allowing it to effectively communicate with a number of otherwise disparate home automation devices.

As outlined in further detail in relation to FIG. 4, the Product App running on smartphone 10 can preferably communicate with access point 14 via internet connection 16 utilizing a service platform, thereby enabling communications between the Product App and an access administrator 200 connected to access point 14 where smartphone 10 cannot directly communicate with access point 14, such as when smartphone 10 is out of wireless range of access point 14.

Electricity management unit 300 is preferably configured to report a broad range of data to the Product App or a service platform. This may include any combination of parameters, metrics, conditions, specifications and time associated with electricity being consumed, an account with a utility, or the condition of the electricity management unit 300, such as, but not limited to: tariffs; billing information; instantaneous voltage, current and power; active, reactive and apparent power; average real power; RMS voltage and current; power factor; line frequency; overcurrent; voltage sag; voltage swell; phase angle; electricity consumed over a defined time period; operational characteristics including any deviation from a specification, limit or base measurement; temperature; service requirements; and/or any other data or metric that may be measured, recorded or stored by the electricity management unit 300. Once the appropriate data has been transferred to the Product App or service platform, the Product App or service platform can preferably perform any necessary calculations or conversions and display the results on the smartphone's touch sensitive screen for the user to view.

In one preferred embodiment, access administrator 200 is preferably configured to route requests from the Product App for data recorded or stored in electricity management unit 300 to electricity management unit 300, and route responses from electricity management unit 300 back to the Product App. In that way, the Product App is preferably configured to exchange data with electricity management unit 300 and access administrator 200 is preferably configured to operate as a router or intermediary facilitating the movement of data between the Product App and electricity management unit 300. By way of example, the Product App may request, via a ZigBee Smart Energy cluster, data stored in an electricity management unit 300 corresponding to the power consumed over a chosen month, that request being routed from the Product App by access administrator 200 to electricity management unit 300 which preferably compiles the data for the chosen month and routes a message through access administrator 200 back to the Product App.

In one preferred embodiment, electricity management unit 300 is preferably configured to continuously, or periodically at a pre-determined sample rate, author, broadcast or multicast repetitive data onto a local communications network with access administrator 200 configured to route the data to the Product App allowing the Product App to dynamically update a field or fields in accordance with variations in the continuous or periodic repetitive data authored, broadcast or multicast by electricity management unit 300. By way of example, electricity management unit 300 may be configured to communicate via a ZigBee Smart Energy cluster to continuously broadcast desirable state data to a PAN or HAN at certain intervals, such as current power usage at a pre-determined sample rate, which access administrator 200 could preferably route to the Product App where the data could be dynamically displayed and vary in accordance with the power measurements being authored by electricity management unit 300.

In one preferred embodiment, electricity management unit 300 is preferably configured to author, broadcast or multicast intermittent data onto a local communications network in response to a change in status, access administrator 200 being configured to route the data to the Product App allowing the Product App to dynamically update a field or fields in accordance the change in status reported by electricity management unit 300. By way of example, electricity management unit 300 may be configured to communicate via a Zig Bee Smart Energy cluster to author, broadcast or multicast a change in state data to a PAN or HAN, such as a change in the tariff, which access administrator 200 could preferably route to the Product App where the tariff field or fields could be updated according to the data authored by electricity management unit 300.

In one preferred embodiment, access administrator 200 is preferably configured to route requests from a service platform for data recorded or stored in electricity management unit 300 to electricity management unit 300, and route messages from electricity management unit 300 back to the service platform.

In one preferred embodiment, access administrator 200 is preferably configured to generate requests for data recorded or stored in electricity management unit 300 and route messages from electricity management unit 300 to the Product App or service platform.

In one preferred embodiment, where electricity management unit 300 is configured to continuously, or periodically at a pre-determined sample rate, author, broadcast or multicast repetitive data onto a local communications network, access administrator 200 is preferably configured to route the data to a service platform.

In one preferred embodiment, where electricity management unit 300 is preferably configured to author, broadcast or multicast intermittent data onto a local communications network in response to a change in status, access administrator 200 is preferably configured to route the data to a service platform. In one preferred embodiment, access administrator 200 preferably operates as a router or intermediary between the Product App, service platform, home automation devices 24 and electricity management unit 300 and does operate as a database for energy measurements from electricity management unit 300 or home automation devices 24 in any way other than to facilitate routing.

The Product App is preferably configured to use a smartphone's cellular or network Wi-Fi capabilities to exchange data with a service platform. Exchange of data with a service platform could include, by way of example only, data for the purpose of calculating or displaying trend analysis, historical analysis, comparative analysis, granular metrics, costing, tariffs, budgets, billing and any other uses of the electrical data measured by electricity management unit 300.

In a preferred embodiment, the Product App is configured to use data from electricity management unit 300, such as tariff data and instantaneous power, and, where necessary or desirable, data from a service platform, to determine and display present energy usage represented in a cost per unit of time, such as dollars per hour. In that way, a user through the Product App may determine the total instantaneous cost per unit of time as an aggregation of the electricity consumed by all electrical apparatus connected to electricity management unit 300 relative to the tariff.

In order to reduce power consumption and promote environmentally friendly energy use, a user may also find it advantageous to determine the consumption metrics of an individual electrical apparatus in a cost per unit of time. The Product App is preferably configured to allow a consumer to “zero” the instantaneous cost per unit of time or instantaneous power displayed to effectively establish a base against which any subsequent variation in electricity consumption measured by electricity management unit 300 could then be used to calculate and display in the Product App an instantaneous cost per unit of time for a desired electrical apparatus relative to the measured variation of electricity consumed from the base. In that way, a user could preferably zero the instantaneous cost per unit of time or instantaneous power in the Product App and then turn on an individual electrical apparatus causing an increase in instantaneous power being measured by electricity management unit 300, the differential being, ceteris paribus, the instantaneous power consumed by the electrical apparatus, the Product App using the differential instantaneous power measurement in combination with the tariff to calculate and display the cost per unit of time to run the chosen electrical apparatus and the rate of energy conversion or transfer with respect to time of the apparatus. Alternately, a user could also preferably zero the instantaneous cost per unit of time or instantaneous power and then turn off an individual electrical apparatus to see how much turning off that apparatus would save represented as a negative cost per unit of time or saving per unit of time.

The Product App is preferably configured to allow the user to save the calculated cost per unit of time associated with an individual electrical apparatus into the Product App to compile a database so that the user may quickly and easily identify and compare the electrical consumption profiles of a range of products and/or systems.

Where a home automation device is capable of measuring and reporting energy consumption metrics, the Product App may preferably be configured to receive energy consumption metrics from a home automation device through access administrator 200 and save the calculated cost per unit of time; cumulative energy consumption data over a period of time; or any other reported energy metric associated with an individual home automation device, into the Product App to compile a database so that the user may quickly and easily identify and compare the electrical consumption profiles of a range of products and/or systems.

In one preferred embodiment, the Product App may be configured to save the calculated cost per unit of time associated with an individual electrical apparatus or home automation device to a service platform or download a cost per unit of time associated with a particular electrical apparatus or home automation device from a service platform.

Where electrical management unit 300 supports time of use tariffs, the Product App preferably displays the cost per unit of time for the present tariff as well as a cost per unit of time for any other tariff. In that way, the Product App may provide a dynamic assessment of the total aggregate electricity consumption in a building, or an electrical apparatus, or collection of electrical apparatus across a number of tariffs allowing a consumer to determine the impact of consuming electricity at a particular rate across those tariffs.

The Product App is preferably configured to allow a user to enter a number of parameters such as the day or days, time of day and for how long an electrical apparatus or home automation device is operational, allowing the Product App to use any combination of cost per unit of time measurements and calculations, tariffs and operational times to display an estimated cost for an individual electrical apparatus, home automation device, or collection of electrical apparatus and/or home automation devices, over the user definable period of time. The Product App is preferably configured to analyse the cost of an individual electrical apparatus, home automation device, or collection of electrical apparatus and/or home automation devices, over a user definable period of time and suggest a means to minimise cost by reducing and/or shifting the use of an apparatus, or apparatus, and/or home automation device or devices, to more efficient days or periods in a day depending on analysis of any variable time of use tariffs. The Product App is preferably configured to offer an alert to avoid operating a particular electrical apparatus, or apparatuses, and/or home automation device or devices in response to an anticipated spike in peak demand or tariff.

In one preferred embodiment, the calculations undertaken in the Product App in displaying the cost per unit of time for the present tariff as well as a cost per unit of time for any other tariff may be performed or assisted by a service platform with the results being reported to the Product App for display.

It can be appreciated that cost per unit of time could equally be substituted or supplemented with a number of different metrics without departing from the scope of the present disclosure. By way of example only, other suitable metrics may include instantaneous power represented in kilowatt hours (kWh), an amount of a greenhouse gas generated per hour, and/or an equivalent carbon emissions value based on the electricity being used. If a carbon emissions metric is utilised, parameters used to calculate a real-time carbon emissions preferably include power usage and power source (e.g., coal burning source, hydro, wind and/or solar). Suitable base carbon emissions values may be obtained for each mode of electrical production in order to facilitate calculations.

Referring to FIGS. 2 and 3, electricity management unit 300 may be configured as a power control device capable of regulating the supply of electricity to one or more other devices and/or circuits within a building. The Product App may be configured to preferably allow a user to issue commands to electricity management unit 300 through access administrator 200, causing electricity management unit 300 to vary the supply of electricity to one or more devices and/or circuits based at least in part on instructions communicated from the Product App. In that way, and by example only, a user could schedule the supply of electricity to one or more devices and/or circuits, the schedule being executed by electricity management unit 300 without needing a communications link between access administrator 200 and the smartphone. System microcontroller 208 may also be configured to preferably issue commands to electricity management unit 300, causing it to vary the supply of electricity to the one or more devices and/or circuits based at least in part on instructions communicated from the Product App. In that way, and by example only, a user through the Product App could configure a schedule in access administrator 200 to vary the supply of electricity to one or more devices and/or circuits under the control of electricity management unit 300, the commands to vary the supply of electricity being generated by access administrator 200 and actioned by electricity management unit 300 without access administrator 200 needing an ongoing communications link with smartphone 10.

Where electricity management unit 300 is capable of varying power to one or more devices and/or circuits within a structure based on a trigger event being received by electricity management unit 300, a user through the Product App may preferably configure an action to be taken by electricity management unit 300 for each of the controllable devices and/or circuits in response to a trigger event. A trigger event may include, but is not limited to, variation of a tariff or the receipt of a demand response command, threshold, flag, notification or data packet.

Where a home automation device has power control capabilities, or is configured as a power control device allowing for the regulation of electricity to one or more appliances, apparatus, devices, products, and/or circuits within a building, the Product App through access administrator 200 may preferably allow a user to control, configure or program functions of that home automation device, including causing it to vary the supply of electricity based at least in part on instructions communicated from the Product App. In that way, and by example only, a user could schedule the supply or consumption of electricity by one or more home automation devices, the schedule being executed by the home automation device without needing a persistent communications link between the smartphone and access administrator. By way of another example, where a home automation device is capable of responding to a demand response condition or change in tariff, the Product App through access administrator 200 may preferably allow a user to configure or program the action that a home automation device is to execute in response to receiving a demand response event or a change in tariff. A demand response event can be generated by access administrator 200, or received and routed through access administrator 200, using any desirable communication channel, which by way of example may include a demand response event sent from a service platform where access administrator 200 is connected to access point 14 and access point 14 has internet connection 16. By way of another example, a demand response event or change in tariff may be generated by electricity management 300, received by access administrator 200 on one HAN or PAN and routed to a different HAN or PAN associated with home automation devices where access administrator 200 is so configured.

Where a home automation device has controllable functions, the Product App through access administrator 200 using local network communications may preferably allow a user to control, configure or program functions of that home automation device. By way of example, where the home automation device is a connected light capable of executing a number of functions, the Product App may preferably be configured to allow a user to control the generic functions of the connected light such as turn on/off, dim, change colour, schedule, etc.

Referring again to FIGS. 2 and 3, in one preferred embodiment, system microcontroller 208 may preferably be configured by the Product App to issue commands to home automation devices based on a pre-configured schedule. Where access administrator 200 is configured as a network client of access point 14 and access point 14 has internet connection 16, system microcontroller 208 may preferably be configured by the Product App to issue commands to home automation devices based on receiving a command from a service platform which may include commands from the execution of an “If This Then That” (IFTTT) recipe. In one preferred embodiment, system microcontroller 208 may preferably be configured by the Product App to issue commands to home automation devices based on a IFTTT recipe executed locally by system microcontroller 208. In that way, and by example only, a user could schedule one or more home automation devices to turn on or off at a pre-determined time or the occurrence of a pre-determined event, the commands for varying the operational state of the home automation devices being generated by system microcontroller 208 or system microcontroller 208 executing commands from a service platform without needing a persistent communications link with smartphone 10. Access administrator 200 could selectively command individual or sub-groups of home automation devices if desired. Such commands may be based on individual parameters associated with each home automation device or sub-group, such as home automation device type and/or power requirement.

Access administrator 200 may include a display if desired. A user preferably uses the Product App to configure the information to be shown on the display. The display preferably shows a series of visual indicators and/or coloured visual indicators and/or characters including any appropriate language support. Microcontroller 208 is preferably able to manipulate the visual elements of the display based on metrics reported from electricity management unit 300 in order to visually allow a user to interpret their electricity metrics at any point in time. By way of example only, the display may dynamically show the cumulative cost in a local currency such as dollars of the total bill for the current reporting period based on the electricity consumption being reported by electricity management unit 300. Coloured indicators may represent the current tariff level in a visual rather than numerical form, ranging, for example, from green for a normal tariff to yellow for shoulder and red for peak tariff conditions. By way of another example, coloured indicators may represent how consumption is tracking against a desired budget in a visual form, ranging, for example, from green to within budget to red for over budget. The display may also preferably include a visual representation of the instantaneous rate of energy being consumed compared to the user's average. In one preferred embodiment, the display may be configured to mirror or mimic the user interface displayed on the smartphone screen.

FIG. 4 is a pictorial representation of a system 400 having a plurality of communication pathways between and amongst smartphone 10, access administrator 200, electricity management unit 300, a service platform 500, a residential or commercial local power management network 600, home automation devices 24, market operator 18 and an electricity industry participant 20. It will be appreciated that other communications pathways or arrangements may be possible and within the scope of the present disclosure.

Several communications pathways are similar to those described above in relation to FIG. 3. In particular, wireless peer-to-peer connection 402 between smartphone 10 and access administrator 200, WLAN connection 404 between access administrator 200 and access point 14, WLAN connection 406 between smartphone 10 and access point 14, and power line communication and/or ZigBee wireless connection 408 between access administrator 200 and electricity management unit 300 are preferably configured as described above for system 100.

Continuing with reference to FIG. 4, service platform 500 is preferably an applications service platform, server, and/or public, private or hybrid cloud programmed with, or containing a software as a service platform that communicates with smartphone 10, and preferably the Product App, via a cellular or internet connection such as connection 410 and/or internet 414, depending on the communications capabilities of smartphone 10 and any connection to the internet.

As shown in FIG. 4, the core of residential or commercial network 600 is preferably composed mainly of elements from system 100 shown in FIG. 3. Network 600 is preferably contained within a building or unit of a building, and in communication with one or more of smartphone 10, service platform 500, and electricity industry participant 20. Market operator 18 is preferably responsible for managing electricity industry participant 20 to ensure the generation and power fed into an electricity grid can satisfy demand at any particular point in time. Electricity industry participant 20 is preferably a party responsible for at least one of the actual generation, transmission, retailing and metering of electricity, for example, a utility company. In certain situations, and depending on a particular nation's regulatory framework, market operator 18 and electricity industry participant 20 may be the same entity without changing the scope of the disclosure.

Because it is very costly and difficult to store electrical energy, the instantaneous demand for power is satisfied through a system of bringing electrical generators online to increase capacity during high consumption periods and taking generators offline to shed load when the electricity being produced exceeds what is optimally required. The supply of power into a grid is typically a competitive process where a market operator 18 through communication pathway 416 puts an offer to the market to purchase an amount of power required to meet anticipated demand. Communication pathway 416 can be formed between two nodes of a communications network and utilise one or more of the internet, wireless, satellite, telephone or a direct line, the actual communication standard and methodology of which is not material as long as data can be exchanged between parties such as market operator 18 and electricity industry participant 20 through a medium and in a format that the recipient can interpret and use. Examples of communications nodes include, but are not limited to computers, servers, wireless radios, routers, and communications gateways. Typically, electricity industry participants such as generators bid to meet the offer of market operator 18 who usually chooses the lowest bid and schedules the electrical supply from the winning generator. Market operator 18 typically utilizes highly sophisticated predictive modelling to anticipate future energy requirements in order to efficiently manage the generation assets of electricity industry participant 20.

In that way, cheaper forms of electricity generation typically provide what is referred to as the base load with more expensive forms of electricity generation supplying what is referred to as peak loads. Cheaper forms of electricity generation typically use higher polluting fuels, such as coal, while more costly forms of electricity generation use cleaner fuels, such as natural gas. Cheaper forms of electricity generation also typically take a long time to bring up to operational speed and are not suitable to meet the uncertain timing of peak power demand. Peak power demand is usually met by generators that can be brought online quickly, but typically consume expensive fuel in order to reach operational speed quickly.

A problem for the electricity industry is that the cycle of peaks and troughs in energy generation and consumption place a strain on the transmission infrastructure; resulting in a very high cost for electricity produced during peak periods; and favouring low cost, but higher polluting generation methods, to supply the bulk of energy requirements. It is therefore highly advantageous to smooth energy consumption by reducing demand during peak periods, while also looking to push energy intensive tasks into off-peak periods to reduce the need for additional base load generation using higher polluting methods.

It will be appreciated that the description of the electricity market above has been simplified considerably, and may differ from market to market. However, this simplification does not substantially affect consideration of the present disclosure.

Service platform 500 preferably includes the necessary computer(s), computing device(s), server(s) and/or technologies capable of one or more of processing, analysing, compiling, transposing, storing, exchanging, transferring, receiving, sending, manipulating and/or displaying data as necessary for purposes that may include capturing, curating, storing, searching, sharing, transferring, analysing and visualizing data or controlling a controllable element in network 600. Service platform 500 can communicate with at least smartphone 10 and one or more of access administrator 200, market operator 18, electricity industry participant 20 and/or another third party, using available communication pathway, or pathways, and communication methods.

Referring again to FIG. 4, in one preferred embodiment, the Product App preferably includes an agent, client, application programming interface (API), or other software interface to facilitate communications between service platform 500 and the Product App using an available communication pathway, or pathways, and communication methods. By way of example, the Product App may communicate with service platform 500 utilizing cellular connection 410 of smartphone 10. By way of another example, the Product App may communicate with service platform 500 where smartphone 10 is connected to access point 14 through WLAN connection 406, and access point 14 has internet connection 16 allowing service platform 500 to communicate with access point 14 via internet 414, thereby allowing service platform 500 and smartphone 10 to form an indirect communications link.

In one preferred embodiment, access administrator 200 preferably includes an agent, client, API, or other software interface to facilitate communications between service platform 500 and access administrator 200 using an available communication pathway, or pathways, and communication methods. By way of example, where access administrator 200 is connected to access point 14, and access point 14 has internet connection 16, access administrator 200 may communicate with service platform 500 via internet 414.

In one preferred embodiment, service platform 500 may preferably be configured as an intermediary for smartphone 10, through cellular connection 410, to remotely communicate with access administrator 200 and control any of the capabilities of, or receive data from, access administrator 200 through internet 414 where access administrator 200 is configured as a client of access point 14 through WLAN connection 404.

It can be appreciated that where service platform 500 and access administrator 200 can establish a communications link, service platform 500 may preferably utilize the communication link with access administrator 200 to communicate with home automation devices 24 also in communication with access administrator 200 through power line communications or ZigBee wireless communications 422. In that way, service platform 500 could preferably control, program or interrogate home automation devices 24 in communication with access administrator 200.

In one preferred embodiment, service platform 500 may preferably act as an intermediary allowing smartphone 10 to remotely control, program or interrogate home automation devices 24 connected to access administrator 200 when smartphone 10 is taken outside the range of local wireless communications within residential or commercial local power management network 600. By way of example, where access administrator 200 is connected to access point 14, and access point 14 has internet connection 16, access administrator 200 may communicate with service platform 500 via internet 414. The Product App running on smartphone 10 may utilize cellular connection 410 to establish a communications link with service platform 500. Service platform 500 can then preferably act as an intermediary allowing the Product App to preferably control, program or interrogate home automation devices 24 in communication with access administrator 200 through power line communications or ZigBee wireless communications 422.

Service platform 500 is preferably capable of communicating and exchanging data with any smartphone running the Product App.

Data that service platform 500 handles may include, but is not limited to, commands, configurations, sensor measurements, forecasting, notifications, analysis of any metric, tariffs, historical information, billing information, usage information, user data, user measurements, location information including global positioning data, demand response configurations, alerts, images, media, alarms, text, state reports, condition reports, support information, customer service information, fault reports, contracts, agreements, request for service, offers, email, short message service (SMS), and push notifications.

It will be appreciated that the data capabilities of service platform 500 allow it to act as an intermediary for a number of services. By way of example, in one preferred embodiment, market operator 18 through communication pathway 412 could supply service platform 500 with forward forecasting of the anticipated demand for electricity. Communication pathway 412 can be formed using any of the structures or methods described above for pathway 416. Using the forward forecast data from market operator 18, service platform 500 preferably generates a message for smartphone 10 warning consumers that a peak demand period is expected at a particular time, and delivers that message using cellular connection 410 and/or internet 414, through WLAN connection 406 between smartphone 10 and access point 14. Consumers then preferably use smartphone 10 through access administrator 200 to interrogate electricity management unit 300 in order to determine current and anticipated energy consumption at the expected peak demand period in order to manage their own power consumption in response to the data from market operator 18.

Any message, notification or alert from service platform 500 to smartphone 10 is preferably delivered as a push notification to the Product App on smartphone 10. It will be appreciated that the use of additional intermediary services from Google™, Microsoft™ Apple™ or another third party may be required in order for service platform 500 to effect a push notification to the Product App. Alternatively, the message from service platform 500 could be delivered by way of SMS to smartphone 10. It will be appreciated that the use of additional intermediary services from a telecommunications company may be required in order for service platform 500 to send an SMS to smartphone 10. If desired, the user may be presented with an option to select a message delivery means as their preferred delivery means. For example, the user may elect to receive notifications via e-mail or SMS.

Service platform 500 preferably directly exchanges data with a party in the electricity industry participant space 20 through communication pathway 418 rather than, or in addition to, market operator 18. Communication pathway 418 can be formed using any of the structures or methods described above for pathway 416.

Referring again to FIG. 4, it will be appreciated that an indirect communication pathway between electricity industry participant 20 and smartphone 10 may be formed utilising one or more of pathways 412/416, 418, 410, 406/414, and 404/402 depending upon the communications capabilities of the smartphone.

Potential uses for a communication pathway between electricity industry participant 20 and smartphone 10, and preferably the Product App running on smartphone 10, could include any one or more of the exchange of data for forecasting, location, notifications, analysis of any metrics, comparative analysis against other consumers, tariffs, historical information, billing information, usage information, user data, user measurements, demand response configurations, alerts, technical support information, customer service information, request for service, offers, contracts, agreements, fault reports, email, SMS and push notifications. By way of example, and with reference to FIG. 4, electricity industry participant 20 through communication pathway 418 could use service platform 500 as an intermediary for supplying smartphone 10 with forward forecasting of the anticipated demand for electricity which electricity industry participant 20 may have received from market operator 18 through communication pathway 416. By way of another example, electricity industry participant 20 through communication pathway 418 could use service platform 500 as an intermediary for supplying smartphone 10 with an alert for a variation in a tariff that electricity industry participant 20 was about to implement in electricity management unit 300 through communication pathway 426. Communication pathway 426 can be formed using any of the structures or methods described above for pathway 416.

Turning again to FIG. 4, smartphone 22 depicts an example of a separate smartphone relative to smartphone 10 that would preferably communicate with the access administrator 200 and electricity management unit 300 installed in the building respective to the owner of smartphone 22. Smartphone 22 may run an entirely different operating system to smartphone 10, but as long as smartphone 22 is adapted to install and run the Product App, it would preferably be able to communicate with service platform 500 in the same way as smartphone 10 running the Product App. Communication pathway 420 preferably replicates the relationships defined for cellular connection 410, internet 414, WLAN connection 406, access point 14 and internet connection 16 in relation to smartphone 10 and service platform 500.

Preferably, the Product App is configured to upload any data stored by it on an associated smartphone; any data extracted from, or reported by, an associated smartphone; any data extracted from, or reported by, an associated access administrator; any data extracted from, or reported by, associated home automation devices; and/or any data extracted from, or reported by, an electricity management unit, to service platform 500. Service platform 500 may choose to share any information uploaded to it with a market operator 18 or an electricity industry participant 20.

Service platform 500 preferably calculates and delivers to smartphone 10 an analysis of the data from one or more of the Product App running on smartphone 10, from electricity management unit 300 and/or from home automaton devices 24, and may perform a comparison with data compiled from one or more of the Product App, electricity management unit and/or home automation devices associated with other smartphones providing data to service platform 500.

By way of example only, the user of smartphone 10 via the Product App may choose to transfer tariff and/or usage data from the Product App and electricity management unit 300 to service platform 500. Service platform 500 preferably delivers comprehensive usage data to smartphone 10, allowing the resident Product App to generate and/or display a comparison against the data supplied by other smartphones reporting to service platform 500. In that way a user could, for example, compare their electricity consumption against an average for the electricity consumed in a similar structure, or analyse the impact of a tariff from an alternate energy retailer on their actual electricity usage and tariff over a defined time period. By way of another example, smartphone owners through the Product App could preferably elect to upload the measured consumption metrics of an electrical apparatus or home automation device to service platform 500. Service platform 500 could create a database 502 (FIG. 4) where other smartphone users through a Product App resident on the smartphone, or through a website portal, could browse the measured consumption metrics of a chosen electrical apparatus or home automation device.

Referring to FIG. 4, database 502 is preferably configured to store consumption metrics from a plurality of sources for one or more electrical devices and/or systems. In a preferred embodiment, platform 500 utilises the consumption data stored in database 502 to generate ratings information for a given electrical apparatus, home automation device or system. It will be appreciated that the data may be stored across a public, private or hybrid cloud if desired rather than a single database server.

The ratings information preferably includes energy efficiency ratings and average power consumption costs over a predetermined time period (e.g., weekly, fortnightly, monthly and/or annual) for each electrical device or system. Each electrical device or system may be categorised by manufacturer, brand, and model.

Conventional energy rating systems often rely on testing performed at a manufacturer or independent government agency. Due to variances in manufacturing methods and conditions, the energy efficiencies of electrical devices and systems often change, making the static testing of products less accurate. One or more preferred embodiments of the systems and methods disclosed herein advantageously permit dynamic energy ratings of electrical apparatuses, home automation devices and systems. For example, as the energy metrics for a given electrical apparatus or system is received by service platform 500 from one or more networks 600 or smartphones (via the Product App), service platform 500 is preferably configured to dynamically update (calculate) and maintain ratings information such as energy efficiency ratings and average power consumption costs for each electrical apparatus and system databased. This information presents a more accurate representation of energy ratings than that offered by conventional systems. The ratings information or data may be used by governments, utilities, and/or manufacturers to promote energy-conscience purchasing of products by offering incentives such as rebates. Such rebates may be tiered based on the particular rating, which may be, for example only, a numerical (e.g., 1 to 5) or symbolic (zero to five star) rating. Other variations are possible and within the scope of the present disclosure.

Service platform 500 may preferably analyze the data from the Product App running on smartphone 10 and/or electricity management unit 300, and deliver to the Product App a comparison showing the differential of alternate tariff(s) supplied by an energy retailer, who is an electricity industry participant, on the electricity usage and tariff provided by the Product App. Service platform 500, by way of the Product App, may preferably be authorized to make an offer on behalf of an energy retailer for the recipient to transfer their electricity billing to the energy retailer making the offer on agreed terms. A recipient of an offer could accept that offer through the Product App, the acceptance of which would be relayed to the appropriate energy retailer in the electricity market by service platform 500.

Data processing performed by service platform 500 may preferably be grouped within pre-defined geographical locations. Service platform 500 is preferably configured to manage or limit communication pathways based on the geographic location of one or more of smartphone 10, access administrator 200, electricity management unit 300, market operator 18 and/or electricity industry participant 20.

Referring again to FIG. 4, it will be appreciated that access administrator 200 may operate as a communication intermediary allowing a smartphone to control, program or interrogate an electricity management unit and home automation devices in a power line communications network and/or ZigBee wireless network or networks. While the topology of electricity management unit 300 and home automation devices 24 operating through separate networks has already been outlined, the present disclosure is not so limited and access administrator 200, electricity management unit 300 and home automation devices 24 may belong to the same network.

In one preferred embodiment, access administrator 200, electricity management unit 300 and home automation devices 24 belong to the same network and communicate using a common communications protocol, standard or specification. The Product App, through access administrator 200, is preferably configured to allow a user to interrogate, program or control home automation devices 24 using power line communications or ZigBee wireless communications 422. The Product App, through access administrator 200, may also be configured to allow a user to interrogate, program or control home automation devices 24 using power line communications or ZigBee wireless communications 424 through electricity management unit 300 acting as an intermediary or network administrator/coordinator.

Referring back to FIG. 4, system 400 is preferably configured to permit automatic and/or manual selective variance of power to individual electrical devices and/or systems by one or more of the smartphone user, service platform, and/or electricity industry participant. For example, a home automation device may be controlled according to a command or schedule implemented through the Product App resident on a user's smartphone. There may be times when it is necessary or preferable to vary or interrupt the schedule due to a triggering event. A trigger may include, but is not limited to, variation of a tariff or the receipt of a demand response command, threshold, flag, notification, or data packet. Where the triggering event is a tariff change, either service platform 500 or electricity industry participant 20 may issue a notification directly to network 600 of a change in tariff. In response thereto, access administrator 200 and/or electrical management unit 300 may issue appropriate commands to one or more home automation devices 24 to vary power, shut off power, or where there is a programmed schedule, delay or reset the schedule. For example, if the tariff unexpectedly will increase, service platform 500 will issue a notification to all networks 600 associated with service platform 500 of the change in tariff. A recipient network 600 receives the notification at access administrator 200 via one of the aforementioned communication methods and proceeds to issue commands to one or more home automation devices 24 to vary the power accordingly. Preferably, home automation devices may be grouped into “essential” and “non-essential” applications. Examples of essential applications include certain lighting systems and appliances such as refrigeration, medical and life support systems. Examples of non-essential applications include pool filtration systems and air conditioning. Preferably, access administrator 200 will issue commands to home automation devices designated as non-essential to vary or shut off power, or if the home automation device is operating according to a schedule, delay or re-schedule.

An example of rescheduling a home automation device is where the home automation device is a power control unit or device for a pool filtration system operating on a programmed schedule. The receipt of a notification of a tariff change by access administrator 200 causes access administrator 200 to send a command to a power control unit controlling the pool filtration system to delay starting a filtration cycle until the tariff is changed to a lower tariff, or rescheduling a pool filtration cycle until a more favourable tariff condition exists. The delaying or rescheduling of a power control unit may be applicable to other devices and systems as desired, for example, air conditioning, heating, lighting, and/or water sprinkler systems.

The designation of “essential” and “non-essential” is preferably made via the Product App according to the user's preferences. It will be appreciated that the Product App may include default designations as appropriate, which may be changed by the user. Alternatively, each home automation device may be pre-configured with a designation which may be modifiable or permanent (i.e., not modifiable). The designation may be made using an appropriately coded flag or tag.

System 400 is preferably configured so that a user controlling a network 600 may elect to include their associated system 600 as a participant for triggering event notifications and responses.

In an example of where the triggering event is a demand response, service platform 500 and/or electricity industry participant 20 may issue the demand response to network 600 to vary or shut off power in a manner similar to that described above for a tariff change. A demand response may be issued, for example, when power demand is approaching a critical level, or when the power grid is being strained in a geographical area as measured by power demand and power available. A demand response may be issued according to predictive modelling, for example, if the weather is predicted to be extreme, causing a spike in energy consumption. Upon receipt of a demand response, network 600 may operate in a manner similar to that described above for receipt of a notification of a tariff change. System 400 may be configured so that in an emergency situation, a demand response may be issued to override any designations in network 600, for example, shutting off or reducing power to all devices or systems serviced within network 600.

Referring now to FIG. 4A, a local power management network 600a is shown in accordance with another preferred embodiment of the present disclosure. Network 600a is similar to network 600 except that electricity management unit 300a is configured to accept a demand response trigger from electricity industry participant 20 directly (e.g., without service platform 500) via communication pathway 426a. Communication pathway 426a can be formed using any of the structures or methods described above for pathway 416. In this situation, a user through the Product App, using access administrator 200a communicating through wireless peer-to-peer connection 402a or WLAN connection 406a and WLAN connection 404a with access point 14, may configure home automation devices 24a directly through power line communications or ZigBee wireless communications 422a, or indirectly via a network using power line communications or ZigBee wireless communications 408a and power line communications or ZigBee wireless communications 424a, with the action to be taken by each home automation device in response to a demand response trigger broadcast by the electricity industry participant through electricity management unit 300a that is propagated or routed over a power line communications network or ZigBee wireless communications network to home automation devices 24a. For example, access administrator 200a may be utilised to configure home automation devices as essential or non-essential, so that when a home automation device receives a demand response trigger from electricity management unit 300a, the home automation device will either react to the trigger if it has been designated as non-essential, or ignore the demand response trigger if it has been designated as essential.

Referring now to FIG. 4B, a local power management network 600b is shown in accordance with another preferred embodiment of the present disclosure. Network 600b is similar to network 600a except that electricity management unit 300b is configured to identify and selectively vary power to circuits to which electricity management unit 300b is wired. In this arrangement, a power control unit is not needed for each electrical device or system since electricity management unit 300b is configured to perform the functions of a power control unit, for example, varying through a power control circuit or relay.

Referring now to FIG. 4C, a system 400c for selectively reducing load across a local power network 600c is shown in accordance with another preferred embodiment of the present disclosure. System 400c is similar to system 400 except that, like network 600b in FIG. 4B, network 600c includes an electricity management unit 300c which is preferably configured to identify and selectively vary power to circuits to which electricity management unit 300c is wired. Additionally, service platform 500c is preferably configured to send, using cellular connection 410c and/or an internet connection, an alert of a change in tariff or strain condition of a local portion of the power grid associated with local power management network 600c to a smartphone 10 associated with local power management network 600c. A user then has an option to use the smartphone to send a command to access administrator 200c to vary power to an electrical device or system through electricity management unit 300c in response to the alert. The command sent to access administrator 200c may be to vary power to non-essential circuits associated with electrical devices and/or systems designated as non-essential. It will be appreciated that instead of electricity management unit 300c being used to vary power to particular circuits, local power management network 600c may be configured with one or more power control units similar to the embodiments illustrated in FIGS. 4 and 4A and described above. System 400c may also be used where electricity management unit 300c has no ability to identify and selectively vary power to circuits, the user instead choosing to manually reduce load by the turning power off to electrical devices, systems or circuits after receiving a notification from service platform 500c.

Referring back to FIG. 4, in a preferred embodiment, a home automation device is preferably configured with WLAN capabilities and operates as a client of access point 14 instead of utilizing power line communication or ZigBee wireless communication technologies. The Product App running on smartphone 10 preferably communicates with a WLAN configured home automation device through either wireless peer-to-peer connection 402 with access administrator 200 to WLAN connection 404 with access point 14, or through smartphone 10 and WLAN connection 406 with Wi-Fi network access point 14. It will be appreciated that data exchange between electricity management unit 300 and a WLAN configured home automation device may be facilitated by access administrator 200 connected to Wi-Fi access point 14.

In one preferred embodiment, a demand response command, threshold, flag, notification, or data packet or a variation in tariff may be used by access administrator 200 to generate a notification or alert transmitted by access administrator to the Product App utilizing any of the communications paths already outlined including communication pathways 402 or 404/406, and may involve service platform 500 including utilizing communication pathway 404/414/410. In one preferred embodiment, a demand response command, threshold, flag, notification, or data packet, or a variation in tariff, may preferably generate a notification or alert for the Product App without routing the demand response or tariff data to home automation devices. In that way a user could receive a notification or alert and then choose what action to take rather than have the system respond automatically.

The foregoing description is by way of example only, and may be varied considerably without departing from the scope of the present disclosure. For example, service platform 500 could be wholly or partly integrated inside market operator 18, a party in electricity industry participant 20, or another third party. In another preferred embodiment, the access administrator may be completely integrated into an electricity management unit or other products. In such an embodiment, the smartphone may have a resident Product App that performs substantially as described above, and be connected with a cord to the mains power, for example, via the smartphone charging unit. As described above, the electricity management unit may include a processor which is configured to identify individual power circuits and individually and selectively vary power to those circuits. Where the electricity management unit is so configured, the use of one or more power control units is optional. The electricity management unit may include a communications module configured for wireless or wired communication with an electricity industry participant so as to receive an event trigger directly from the electricity industry participant (e.g., not through the personal controller or service platform).

Referring to FIGS. 4, 4A, 4B and 4C, where an electricity management unit requires pre-payment in order to supply electricity to a premises, the Product App may preferably be configured to facilitate pre-payment and may make use of any suitable communication path in loading credit into an electricity management unit.

FIG. 5 shows an access administrator 800 in accordance with another preferred embodiment of the present disclosure. Access administrator 800 provides an example of an alternate configuration of the systems of access administrator 200. Access administrator 800 preferably includes Wi-Fi communications 802, Wi-Fi aerial 804, Bluetooth communications 806, Bluetooth aerial 808, system microcontroller 810 with embedded memory, perpetual clock calendar 812, electricity management unit communications 814, electricity management unit communications aerial 816, power line coupler 818, power line connection 820, and system power supply 822. It will be appreciated that Wi-Fi communications 802 and Bluetooth communications 806 will each include at least one appropriately configured radio and circuitry. In some preferred embodiments, it may be preferable for system microcontroller 810 to support external memory in addition to, or instead of, embedded memory. In some preferred embodiments, it may be preferable to aggregate Wi-Fi communications 802 and Bluetooth communications 806 as a component, SiP, PoP or SoC allowing for a single aerial. It will be appreciated by those of ordinary skill in the art that the system described above can be varied in many ways without departing from the scope of the present disclosure.

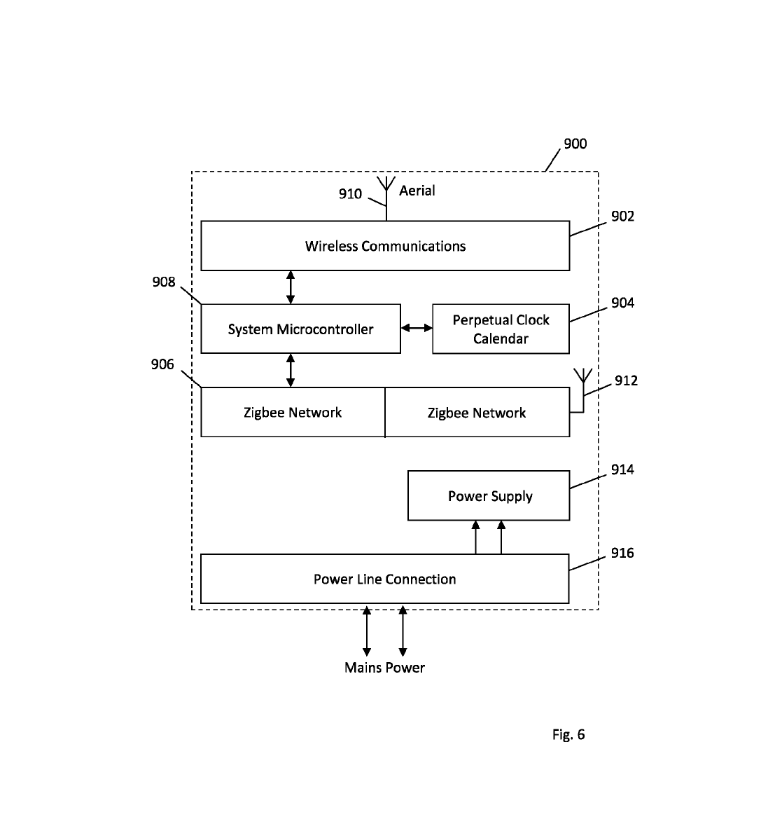

FIG. 6 shows an access administrator 900 in accordance with another preferred embodiment of the present disclosure. Access administrator 900 provides an example of a preferred configuration of the systems of access administrator 200. Access administrator 900 is a physical device that preferably includes wireless communications 902, perpetual clock calendar 904, local network communications 906, system microcontroller 908 with embedded memory, wireless communications aerial 910, local network communications aerial 912, system power supply 914 and power line connection 916. In some preferred embodiments, it may be preferable for system microcontroller 908 to support external memory in addition to, or instead of, embedded memory.

Wireless communications 902 preferably utilizes any combination and number of integrated circuits, components, controllers, transceivers, radios, memory, microprocessors, and aerials that provide both network Wi-Fi and Wi-Fi Direct communication capabilities individually or concurrently. In some preferred embodiments, wireless communications 902 preferably includes any combination and number of integrated circuits, components, controllers, transceivers, radios, memory, microprocessors, and aerials to provide wireless Bluetooth communication capabilities.

Local network communications 906 preferably includes any combination and number of integrated circuits, components, controllers, transceivers, radios, memory, microprocessors, and aerials to provide more than one wireless personal area network, for example, ZigBee, running simultaneously or concurrently, where each of the simultaneous or concurrent ZigBee networks may operate using a different ZigBee protocol, standard, application profile or specification where desirable. Preferably, local network communications 906 is configured with a dual-network capable SoC, PoP or SiP having a single IEEE 802.15.4 radio configured to participate in two ZigBee networks by maintaining two sets of network parameters. In one preferred embodiment, local network communications 906 may preferably utilize a single IEEE 802.15.4 radio configured with multiple application profiles, or a version of ZigBee that amalgamates various ZigBee standards into a single unified standard such as ZigBee 3.0 or later. Where local network communications 906 utilizes a unified standard of ZigBee, such as ZigBee 3.0 or later, it may preferably include security measures specifically implemented to support ZigBee Smart Energy such as additional security based on elliptical curve cryptography.

In one preferred embodiment, local network communications 906 may preferably include any combination and number of integrated circuits, components, controllers, transceivers, radios, memory, microprocessors, and aerials to transmit ZigBee communications on a carrier frequency of 2.4 GHz and a frequency under 1 GHz, operating simultaneously or selectively.

Power line connection 916 is a physical interface for connecting access administrator 900 to the mains power wiring in a building. In one preferred embodiment, power line connection 916 is preferably configured for compatibility with the NEMA 5-15 North American or BS 1363 mains power standard allowing access administrator 900 to plug directly into a mains power general purpose outlet. In one preferred embodiment, access administrator 900 may take the physical form of a fully self-contained plug in pack or “wall wart”. In another preferred embodiment, access administrator 900 may be configured as a table top unit and utilize a power adapter. In another preferred embodiment, power line connection 916 may preferably incorporate a terminal block configured for wiring directly into the mains power of a building or structure and may be configured in a wall panel, or behind a wall mounted panel, or integrated into a general purpose power outlet. In another preferred embodiment, the access administrator may be configured as a DIN rail mountable module for installation inside a switch-box or fuse-box. It will be appreciated that access administrator 900 may be configured according to the wiring, connecting, mounting, plug and socket, and current and voltage requirements of various countries and applications without departing from the scope of the present disclosure.

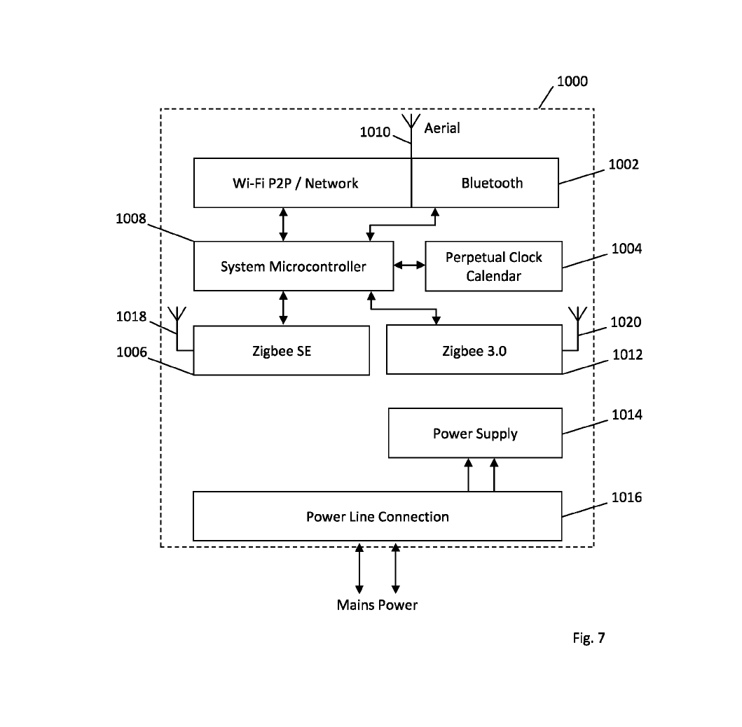

FIG. 7 shows an access administrator 1000 in accordance with another preferred embodiment of the present disclosure. Access administrator 1000 provides an example of a preferred configuration of the components of access administrator 200. Access administrator 1000 is a physical device that preferably includes wireless communications 1002 with wireless communications aerial 1010, perpetual clock calendar 1004, local network communications 1006 with local network communications aerial 1018, local network communications 1012 with local network communications aerial 1020, system microcontroller 1008 with embedded memory, system power supply 1014 and power line connection 1016. In some preferred embodiments, it may be preferable for system microcontroller 1008 to support external memory in addition to, or instead of, embedded memory.

Wireless communications 1002 preferably utilizes any combination and number of integrated circuits, components, controllers, transceivers, radios, memory, microprocessors, and aerials that provide both network Wi-Fi and Wi-Fi Direct communication capabilities and wireless Bluetooth communication capabilities, individually or concurrently. Preferably, wireless communications 1002 is a SoC, PoP or SiP configured with memory, a Wi-Fi radio, a Bluetooth radio and a dedicated microcontroller to manage both Wi-Fi and Bluetooth communications and network requirements including shared aerial support for wireless communications aerial 1010.

Local network communications 1006 preferably includes any combination and number of integrated circuits, components, controllers, transceivers, radios, memory, aerials and microprocessors to operate according to a ZigBee Smart Energy protocol, standard, application profile or specification. In one preferred embodiment, local network communications 1006 may be SoC, PoP or SiP that includes memory, a single IEEE 802.15.4 radio and a dedicated microcontroller to manage communications and ZigBee Smart Energy network requirements including network parameters to participate in a Zigbee Smart Energy network coordinated by electricity management unit 300 as an end device or router. Local network communications 1006 preferably communicates through local network communications aerial 1018 although more than one aerial may be used where local network communications 1006 is configured to operate simultaneously or selectively on more than one carrier frequency, such as a carrier frequency of 2.4 GHz and a frequency under 1 GHz.

Local network communications 1012 preferably includes any combination and number of integrated circuits, components, controllers, transceivers, radios, memory, aerials and microprocessors to operate according to a ZigBee protocol, standard, application profile or specification suitable for home automation, such as ZigBee 3.0 or later. In one preferred embodiment, local network communications 1006 may be SoC, PoP or SiP that includes memory, a single IEEE 802.15.4 radio and a dedicated microcontroller to manage communications and ZigBee 3.0 network requirements including network parameters to coordinate a ZigBee 3.0 network. Local network communications 1012 preferably communicates through local network communications aerial 1020 although more than one aerial may be used where local network communications 1012 is configured to operate simultaneously or selectively on more than one carrier frequency, such as a carrier frequency of 2.4 GHz and a frequency under 1 GHz.

Power line connection 1016 is a physical interface for connecting access administrator 1000 to the mains power wiring in a building. In one preferred embodiment, power line connection 1016 is preferably configured for compatibility with the NEMA 5-15 North American or BS 1363 mains power standard allowing access administrator 1000 to plug directly into a mains power general purpose outlet. In one preferred embodiment, access administrator 1000 may take the physical form of a fully self-contained plug in pack or “wall wart”. In another preferred embodiment, access administrator 1000 may be configured as a table top unit and utilize a power adapter. In another preferred embodiment, power line connection 1016 may preferably incorporate a terminal block configured for wiring directly into the mains power of a building or structure and may be configured in a wall panel, or behind a wall mounted panel, or integrated into a general purpose power outlet. In another preferred embodiment, access administrator may be configured as a DIN rail mountable module for installation inside a switch-box or fuse-box. It will be appreciated that access administrator 1000 may be configured according to the wiring, connecting, mounting, plug and socket, and current and voltage requirements of various countries and applications without departing from the scope of the present disclosure.

Access administrator 1000 is preferably configured so that system microcontroller 1008 may utilize the microcontroller and memory of a SiP, PoP or SoC implementation of wireless communications 1002, local network communications 1006 and/or local network communications 1012 to perform a function, or support system microcontroller 1008 in performing a function, thereby sharing the computational load across a number of processing elements and maximizing the computational power of access administrator 1000. By way of example, the ZigBee Smart Energy application profile is preferably stored in the memory of a SiP, PoP or SoC implementation of local network communications 1006 and executed by a microcontroller within local network communications 1006 rather than system microcontroller 1008.

In one preferred embodiment, the functional capabilities of system microcontroller 1008 may be aggregated within a SiP, PoP or SoC implementation of wireless communications 1002, local network communications 1006 and/or local network communications 1012 where the SiP, PoP or SoC microcontroller is sufficiently powerful enough to also perform the role of system microcontroller. External memory can be added to a SiP, PoP or SoC within access administrator 1000 where desirable.

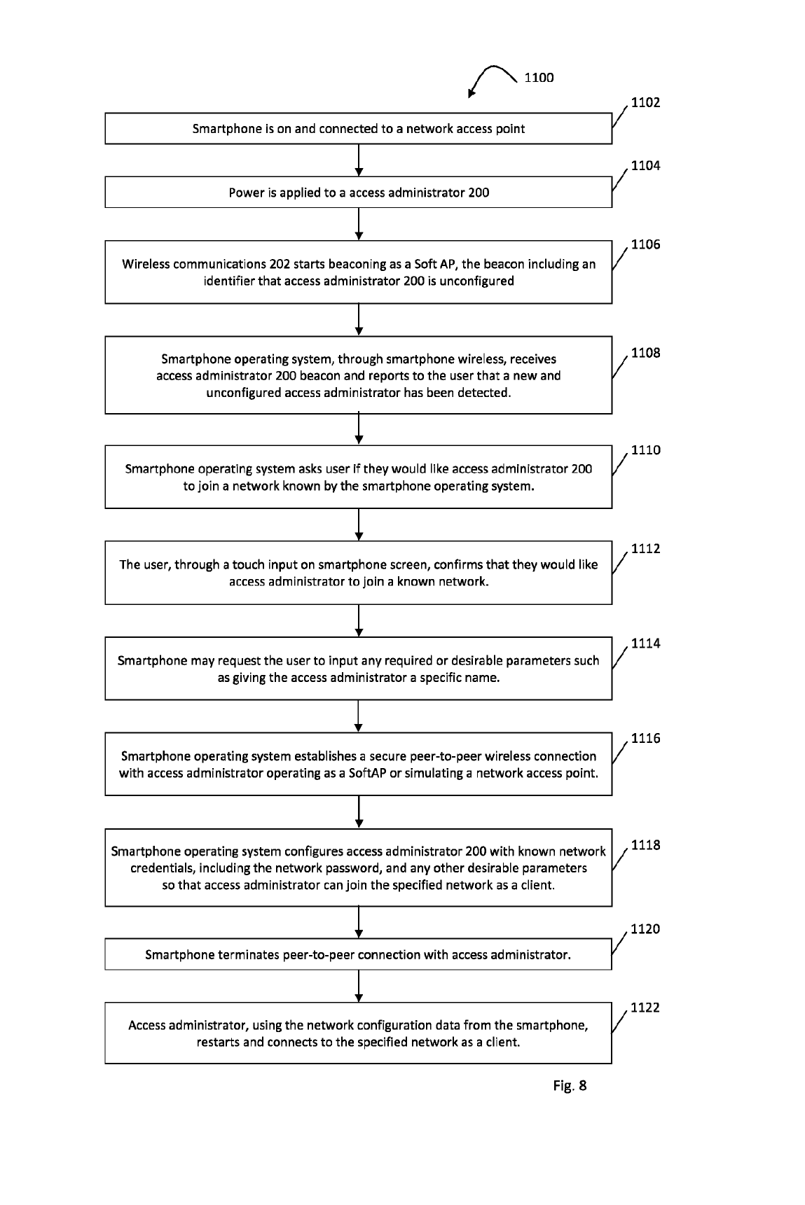

Turning now to FIG. 8, an exemplary configuration procedure 1100 is shown for configuration of access administrator 200 as a client of a Wi-Fi network by smartphone 10 in a preferred embodiment of the present disclosure. While configuration procedure 1100 has been described in relation to a smartphone operating system, configuration procedure 1100 is not so limited and may be performed by the Product App where the Product App is able to control smartphone wireless communications as required.

At step 1102, smartphone 10 is connected to a network access point, such as Wi-Fi network access point 14 in FIG. 2. At step 1104 power is applied to access administrator 200 for the first time, allowing access administrator 200 to run all of its systems. At step 1106, wireless communications 202, configured to simulate a Wi-Fi network access point or operate as a SoftAP, begins to wirelessly beacon its network information. The wireless beacon preferably includes an identifier or service discovery component that reports access administrator 200 as an unconfigured network Wi-Fi device to Wi-Fi devices configured to interpret the identifier. At step 1108, the smartphone operating system through the smartphone's wireless transceiver, receives access administrator 200 beacon, determines from the identifier in the beacon that access administrator 200 is an unconfigured access administrator and reports to the user via the smartphone touch screen that it has detected a new and unconfigured access administrator. At step 1110, the smartphone operating system asks the user if they would like access administrator 200 to join a known Wi-Fi network, preferably the network smartphone 10 is currently connected to. At step 1112, the user through a touch input on the smartphone screen confirms they would like the unconfigured access administrator to join a network known by the smartphone operating system.

At step 1114, the smartphone operating system may require the user to enter a desirable or required parameter, such as a security code used in establishing a communications link between smartphone 10 and system microcontroller 206, or giving unconfigured access administrator 200 a specific name to be used during configuration as a network client. It can be appreciated that step 1114 may be excluded where providing the quickest and easiest mechanism for configuration of an access administrator 200 by smartphone 10 as a client of a network known by smartphone 10 is desirable, or where elements of step 1114 may be performed after access administrator 200 is configured and connected to a network as a client, such as giving access administrator 200 a unique name.

At step 1116, the smartphone operating system establishes a secure peer-to-peer Wi-Fi connection with access administrator 200 preferably configured to simulate a network access point or operate as a SoftAP. The opening of a secure peer-to-peer Wi-Fi connection may include the utilization of authentication hardware, firmware or software integrated into access administrator 200 and smartphone 10, so that access administrator 200 may automatically establish a secure connection with smartphone 10 utilizing an authentication handshake without requiring the user to input any security credentials manually. It can be appreciated that where smartphone 10 is unable to support a simultaneous connection with a network access point and a device simulating a Wi-Fi network access point or operating as a SoftAP, such as access administrator 200, smartphone 10 may disconnect from the Wi-Fi network access point in order to establish a secure peer-to-peer Wi-Fi connection with access administrator 200.

At step 1118, the smartphone operating system configures access administrator 200 with the network credentials of a known network, including the network password, and any other desirable or necessary parameters so that access administrator 200 can join the specified network as a network Wi-Fi client device. At step 1120, the smartphone operating system terminates the peer-to-peer Wi-Fi connection with access administrator 200. If the smartphone operating system disconnected from a network access point in order to establish a peer-to-peer Wi-Fi connection with access administrator 200 at step 1116, the smartphone operating system preferably re-establishes a connection with the network access point. At step 1122, access administrator 200, using the network configuration data from the smartphone operating system, configures itself according to the network parameters supplied as a network Wi-Fi device and connects to the specified network access point as a client, after which access administrator 200 and smartphone 10 are preferably able to discover each other and communicate with through the network access point.

In one preferred embodiment, it may be preferable for access administrator 200 and smartphone 10 to utilize Wi-Fi Direct in establishing a peer-to-peer connection in configuration procedure 1100.

It will be appreciated that certain steps outlined in configuration procedure 1100 may be modified, deleted or added without departing from the scope of the present disclosure. For example, configuration procedure 1100 may be adapted for execution by the Product App rather than a smartphone operating system. By way of another example, smartphone operating system may cause access administrator 200 to start its configuration procedure after confirmation by the access administrator that it has successfully received the network parameters from the smartphone, or system microcontroller 208 of access administrator 200 may terminate the peer-to-peer connection with the smartphone and start its configuration procedure after successfully receiving network parameters from the smartphone without the smartphone operating system needing to initialize the process.

The system preferably includes a budget feature to help a user control their energy costs. Preferably, a user may enter into one or more fields of the Product App a desired budget for a defined period of time. Referring to FIG. 4, the Product App preferably uses the data from electricity management unit 300 and/or data from a service platform 500 to display the current cumulative consumption for the relative sample period within the defined budget period, thereby allowing the user to determine how much of their budget had been used at that point. The Product App preferably calculates the average consumption over the analyzed sample period and applies the average to the defined budget period to determine if the current average rate of consumption would result in the desired budget being exceeded. The Product App may visually display the result graphically and/or numerically and provide an indication of the anticipated cost for the defined budget period. In one preferred embodiment, where the current rate of rate consumption would result in the desired budget being exceeded, the Product App may suggest a target consumption rate to meet the desired budget.

By way of example, the weekly budget may be set by a user in the product App at $35, corresponding to a daily budget of $5. The electricity consumption over the first four days of the budget period may be recorded by electricity management unit 300 as day 1=$4, day 2=$5, day 3=$6, day 4=$7. At the end of day 1, the Product App, with only one daily sample set, would show the cumulative consumption at $4 and use a $4 average across the 7 day budget period to calculate an anticipated cost at the end of the budget period at the current average rate of consumption to be $28. At the end of day 2, the Product App would show the current cumulative consumption at $9 (day 1+day 2) and would sum the two daily samples and divide by the number of sample days to ascertain the daily average and then multiply this by the 7 days of the budget period to calculate the anticipated cost at the end of the budget period at the current average rate of consumption to be $31.50. ($4+$5)/2×7=$31.50. The Product App's anticipated cost at the end of the budget period at the current average rate of consumption would accordingly revise to $31.50 given the higher level of consumption on day 2. At the end of day 3, the Product App using the same methodology would show the cumulative consumption at $15 with an anticipated cost at the end of the budget period at $35. At the end of day 4, the Product App using the same methodology would show the cumulative consumption at $22 with an anticipated cost at the end of the budget period at $38.50. The Product App's anticipated cost at the end of the budget period at the current rate of consumption would accordingly revise to $38.50, at which point the Product App would preferably indicate that maintaining the current average rate of consumption will exceed the budget. Where so configured, the Product App may suggest a daily average target of consumption for the remaining 3 days at $4.33 in order to deliver an overall 7 day average that meets the desired budget of $35.

In one preferred embodiment, it may be desirable for the Product App to display the target cumulative consumption at each point in time relative to the actual cumulative consumption in order to provide a comparative basis in determining how far above or below their target a user's current cumulative consumption is trending.

It can be appreciated that any budget period or sample rate may be utilized without departing from the scope of the present disclosure. By way of example, the budget period may be set to 24 hrs and the sample rate reduced to 5 mins or less where accurate budget tracking is essential or desirable.

In some markets, the supply of electricity includes a service charge or standing charge in addition to a unit rate applied to the amount of energy consumed. In that instance the Product App preferably apportions the service charge or standing charge as fixed component in the time scale used for any budget calculation. By way of example, an annual service charge of $365 for a non-leap year would correspond to a service charge of $1.00 per day as a fixed component to which any electricity consumption on a per unit rate would be added in tracking against a desired daily budget. The Product App may preferably download a customer's specific service charge or standing charge from service platform 500, retrieve it from an electricity management unit 300 where available, or allow a user may manually enter it directly into the Product App.

In one preferred embodiment, the Product App may preferably conduct budget calculations in the background and alert a user where it calculates that the current rate of rate consumption would result in the desired budget being exceeded.

Referring again to FIG. 4, in one preferred embodiment, a user through the Product App may preferably manually or automatically set a budget threshold in access administrator 200, or service platform 500, which can be used as a trigger to generate a budget notification or alert. A budget threshold is the desired billable total cost of electricity that a user wishes to pay over a defined period of time. By way of example this may be $5.00 per day. Access administrator 200, preferably continuously or periodically polls electricity management unit 300 and requests from electricity management unit 300 the total cost of electricity consumed from the start of the budget period up to the time of the request within the budget period and compares this with the user defined budget threshold to determine if the budget threshold has been exceeded.

By way of example, if the budget period is 24 hrs starting at 00:00 and the budget threshold is $5.00, access administrator 200 preferably polls electricity management unit 300 periodically according to a defined sample rate, such as 15 minute increments, and requests the total cost of electricity consumed at that point in time to the beginning of the budget period at 00:00. In that way, and by way of example, access administrator 200 at 00:15 requests electricity management unit 300 for the cost of electricity consumed from 00:00 to 00:15 and continues to do this for each 15 minute increment over the next 24 hrs. At 10:00 access administrator 200 would request electricity management unit 300 for the cost of electricity consumed from 00:00 to 10:00. Access administrator 200 preferably continues to request from electricity management unit 300 the total cost of electricity consumed from the time of the request back to the start of the budget period. If during a requested period, electricity management unit 300 reports an aggregated consumption greater than the budget threshold, access administrator 200 preferably sends a notification or alert to the Product App that the budget has been exceeded. An alert may utilize any available communication path to the Product App as outlined in the communication topologies in relation to FIG. 4, which, for example, may include service platform 500 and a cellular data connection to smartphone 10 if smartphone 10 is outside of the peer-to-peer range of access administrator 200 or is not locally connected to the same WLAN as access administrator 200.

In one preferred embodiment, rather than setting a budget threshold in access administrator 200, the Product App may set a budget threshold in service platform 500. Service platform 500 through access administrator 200, or an access administrator on behalf of service platform 500, preferably continuously or periodically obtains from electricity management unit 300 the total cost of electricity consumed from the start of the budget period up to the time of the request and routes this data to service platform 500, where service platform 500 compares the total cost of electricity consumed during the request period to the budget threshold and sends a budget notification or alert to the Product App if the threshold is exceeded. In one preferred embodiment, where the Product App is used to set a budget threshold in service platform 500, service platform 500 may preferably receive data corresponding to the total cost of electricity consumed from electricity management unit 300 through the advanced metering infrastructure or wide area network rather than, or in addition to, data from access administrator 200. By way of example, this could be a customer's billable data from market operator 18 or electricity industry participant 20.

In one preferred embodiment, it may be desirable for access administrator 200 or service platform 500 to locally record or update a rolling total cost from the start of a budget period.

In one preferred embodiment the actual budget threshold may be a percentage of the desired budget threshold allowing a notification or alert to be generated before the desired budget threshold is exceeded. By way of example, where the desired budget threshold is $5.00 per day, the actual budget threshold utilized or programmed by the Product App may be 80% of the desired budget threshold for an actual budget threshold of $4.00, thereby generating a notification or alert before the desired budget threshold is exceeded. It can be appreciated that any desirable percentage can be used without departing from the scope of the present disclosure and that multiple notifications or alerts may be generated at different budget threshold percentages to provide more than one warning as consumption moves closer to the desired budget threshold.

In one preferred embodiment, a user through the Product App may preferably manually or automatically set a budget threshold in access administrator 200, or service platform 500, which can be used by access administrator 200 or service platform 500 as a trigger to execute a pre-configured command to a chosen home automation device causing it to switch off or reduce power consumption in response to a budge threshold, or a percentage of a budget threshold, being met.

It can be appreciated that the budget threshold feature of the Product App, service platform 500 and access administrator 200 can be modified in a number of ways without departing from the scope of the present disclosure. For example, the sample rate access administrator 200 uses in polling electricity management unit 300 may be any desirable time interval and may range from seconds to hours, or may be limited to the data refresh rate or authoring rate of electricity management unit 300. By way of another example, the budget period may be any desirable time interval, for example a day, week, month, year, etc., and start at any desirable time of day. By way of another example, electricity management unit 300 may be configured to author or publish consumption data onto a network rather than require the Product App, access administrator 200 or service platform 500 to poll electricity management unit 300.

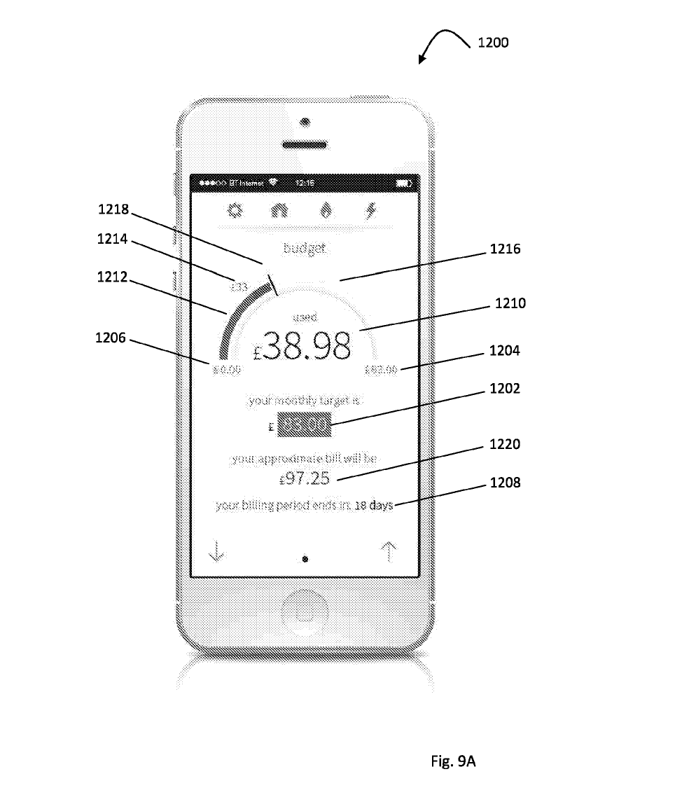

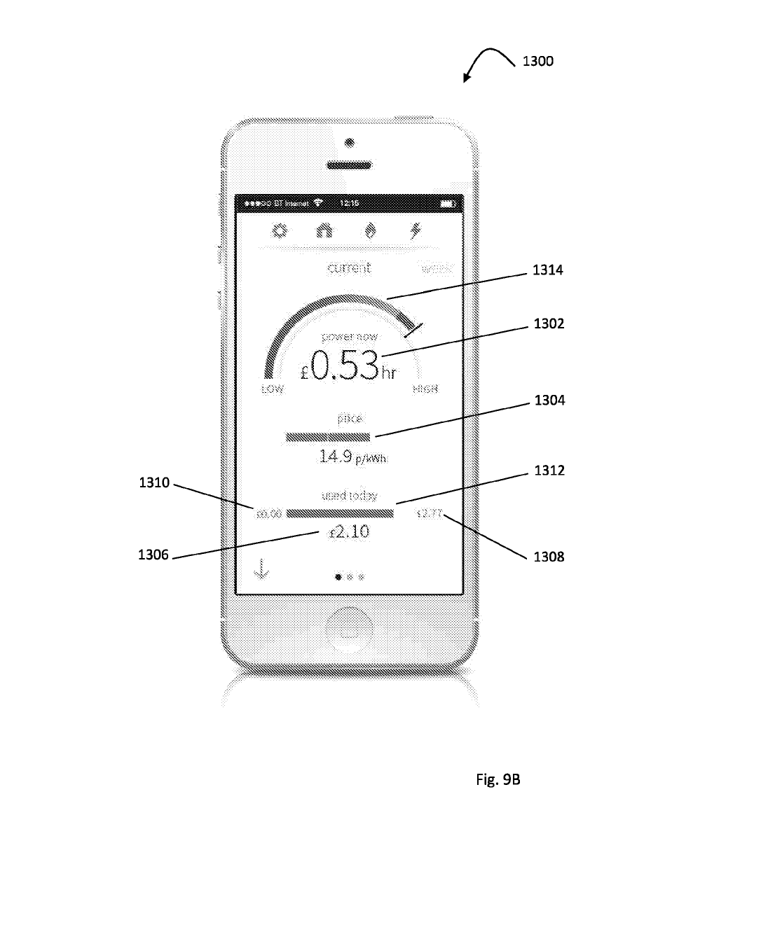

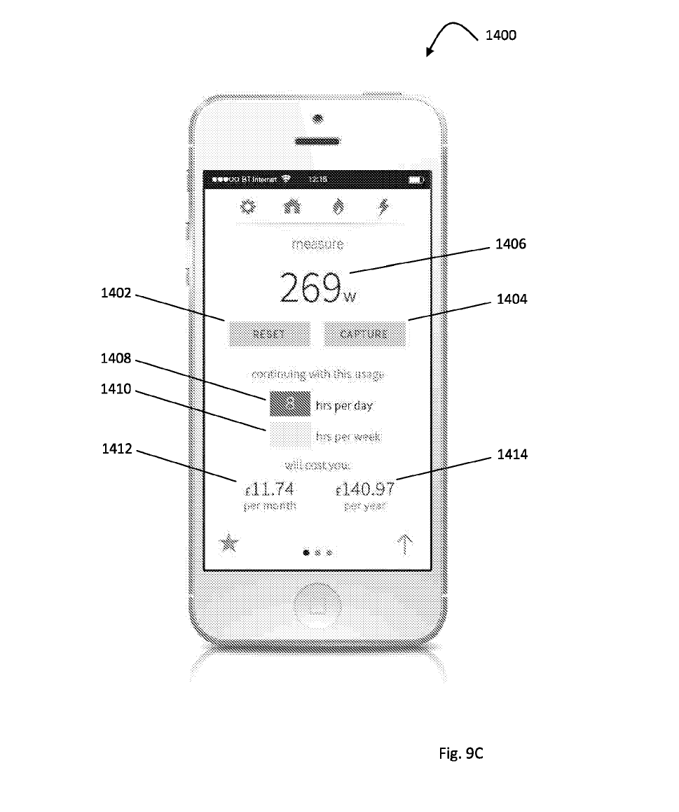

FIG. 9A is a pictorial representation of a budget tool 1200 within the Product App in accordance with a preferred embodiment of the present disclosure. At field 1202 a user can preferably enter the budget threshold for the budget period. At field 1204, the Product App preferably utilizes the budget threshold to populate the maximum budget value in visual indicator 1216. At field 1206, the Product App preferably displays a starting budget value in visual indicator 1216. This is preferably a nominal zero currency value where the utility does not apply a service charge or standing charge, or a value corresponding to the service charge or standing charge apportioned for the budget period. At field 1208, the Product App preferably displays the time remaining in the budget period. At field 1210, the Product App preferably displays the current cumulative consumption for the sample period. At 1212, visual indicator 1216 preferably displays current cumulative consumption in relation to the budget threshold. Where current cumulative consumption exceeds the budget threshold for the sample period, the visual indicator preferably segments with a colour, such as green, up to point 1214, which preferably includes a numerical value indicating the budget threshold target for the sample period. Point 2014 is preferably calculated by: taking the budget threshold; adding any service or standing charge for the budget period; dividing the result by the total number of samples in the budget period to determine an average currency value per unit of time; then multiplying the average currency value per unit of time by the number of samples in the sample period. After point 2014, visual indicator would preferably segment with a different colour, such as red, up to indicator 1218, indicator 1218 corresponding to current cumulative consumption 1210. Where current cumulative consumption is under the cumulative budget threshold average for the sample period, point 2014 and indicator 1218 preferably swap relative positions, with point 2014 appearing to the right of indicator 1218. Between point 2014 and indicator 1218, visual indicator 1216 may preferably utilize a different color or shade, such as lighter green, to indicate current cumulative consumption tracking under the budget threshold target for the sample period. At field 1220, the Product App preferably displays the anticipated cost at the end of the budget period.

FIG. 9B is a pictorial representation of an information screen 1300 within the Product App in accordance with a preferred embodiment of the present disclosure. At field 1302, the Product App preferably displays the present energy usage represented in a cost per unit of time. At field 1304, the Product App preferably displays the current tariff in a numerical value corresponding to a price per unit of energy and through a visual indicator that represents where the current tariff is positioned within the tariff scale. In one preferred embodiment, the tariff field may include an indicator for what the next tariff will be and the time it is due to take effect. This may preferably utilize a dynamically updating time scale graphic. At field 1306, the Product App preferably displays the current cumulative consumption for the current day. At field 1308, the Product App preferably displays the budget threshold for the day derived from the budget threshold entered into field 1202. At field 1310, the Product App preferably displays a starting budget value. This is preferably a nominal zero currency value where the utility does not apply a service charge or standing charge, or a value corresponding to the service charge or standing charge apportioned to a day. At 1312 a visual indicator preferably shows how much of the daily budget threshold has been consumed up to that point in time. The visual indicator may use colours to indicate a condition within, or outside, the desired target budget. Visual indicator 1314 is preferably configured to message a desired attribute. In one preferred embodiment, visual indicator 1314 is preferably configured to display where the present energy usage represented in a cost per unit of time ranks comparatively to the average energy usage represented in a cost per unit of time for electricity management unit 300, thereby allowing a user to determine the relative expense of their present energy usage. In one preferred embodiment, visual indicator 1314 is preferably configured to display where the present energy usage represented in a cost per unit of time ranks comparatively to the average household energy usage represented in a cost per unit of time for comparable households to the household electricity management unit 300 is installed in. It can be appreciated that data from service platform 500 may be used in calculating or presenting a graphically desirable attribute in visual indicator 1314.

FIG. 9C is a pictorial representation of an appliance measurement tool 1400 within the Product App in accordance with a preferred embodiment of the present disclosure. At field 1402, a user can preferably zero the instantaneous power displayed in field 1406, that data acquired from electricity management unit 300. At field 1404, a user can preferably start a measurement process whereby the Product App preferably instructs the user to turn on the appliance for which a measurement is desired. The Product App, in communication with electricity management unit 300, preferably waits for a predetermined period of time, for example 20 seconds, so that the change in instantaneous power caused by switching the appliance on can be detected and reported by electricity management unit 300 according to electricity management unit's own sample rate and reporting parameters. At the end of the measurement period, the Product App preferably updates field 1406 with the instantaneous power differential corresponding to the power consumed by the apparatus during the measurement period. At field 1408, the user can preferably enter the number of hours per day that they use the appliance. Alternately, at field 1410 the user can preferably enter the number of hours per week that they use the appliance being more convenient for appliances that are used on a periodic rather than daily basis, such as washing machines. The Product App preferably utilizes the instantaneous power differential measurement, current tariff and the number of hours the appliance is used per day or week to calculate an approximate cost for using the appliance per month at field 1412 and per year at 1414. Where electricity management unit 300 is configured to charge time of use tariffs, the Product App may preferably be configured in fields 1412 and 1414 to show a breakdown of cost per week or month across a number of tariffs, thereby allow a user to determine the impact of running an appliance during different tariff periods.

It can be appreciated that budget tool 1200, information screen 1300 and appliance measurement tool 1400 can be modified in a number of ways without departing from the scope of the present disclosure. By way of example, fields may be omitted, added or varied as required, or different units of time, currency, or value can be used in a calculation or displaying a result. By way of another example, any underlying mathematical equations giving effect to a result displayed in a field or fields may increase in sophistication to deliver more accurate analysis or predictive results taking into consideration such things as tariff variations and the difference in energy consumed between the week, weekends, day and night.

In one preferred embodiment, a budget threshold entered into the Product App is preferably transferred to service platform 500 where it is preferably associated with electricity management unit 300. Where a budget threshold is exceeded during a budget period, service platform 500 preferably records the power consumed utilizing data from electricity management unit 300 to determine if a user has taken steps to reduce their power consumption in reaching the desired budget threshold by the end of the budget period. Service platform 500 preferably records the budget threshold, the amount by which a budget threshold is exceeded, the frequency that a budget threshold is exceeded and the level of power consumption after a budget threshold is exceeded so that the price elasticity of demand for an associated customer can be ascertained. In one preferred embodiment, service platform 500 may rank customers based on their budget threshold, the amount of power actually consumed and their price elasticity. Aspects of the present disclosure may be used in a variety of environments. For example only, the disclosure can be adapted for use with gas meters (e.g., natural gas) and water meters, as well as electricity meters for use with home-generated electrical apparatuses such as a PV solar system and/or wind turbine.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A device for linking a personal controller to a smartmeter and a home automation device, the personal controller having a processor, a user interface, and a wireless communications transceiver, the smartmeter being configured to at least measure power flow, said device comprising:
a wireless communications module operable for wireless communication with the personal controller, said wireless communications module including a radio transceiver, said wireless communications module being configured to communicate wirelessly with the personal controller in at least two different modes, a first of the modes being a peer-to-peer communications mode, a second of the modes being a non-peer-to-peer communication mode;
a local network communications module operable for communication with each of the smartmeter and with the home automation device, said local network communications module including a radio transceiver configured to operate a wireless personal area network, said local network communications module being configured to communicate with the smartmeter using a first application profile, said local network communications module being configured to communicate with the home automation device using a second application profile different from the first application profile; and
a microcontroller configured to access, through said local network communications module, each of the smartmeter and the home automation device based at least in part on instructions communicated from the personal controller through said wireless communications module, said microcontroller being configured to report energy usage data without storing the energy usage data within said device.

2. The device of claim 1, wherein said local network communications module is configured to communicate with the smartmeter using only a wireless personal area network communications specification based on an IEEE 802.15 series communications standard.

3-6. (canceled)

7. The device of claim 1, wherein said microcontroller is configured to communicate with the smartmeter using a network key to form a secure network between said device and the smartmeter.

8. The device of claim 1, wherein said microcontroller is configured to open a peer-to-peer wireless communication link with the personal controller using a SoftAP.

9. (canceled)

10. The device of claim 1, further comprising an interface connection for physically connecting said device to a mains power line, said interface connection including a terminal block configured for wiring directly into the mains power line.

11. The device of claim 1, wherein said local network communications module includes a single radio configured to communicate with the smartmeter using the first application profile and communicate with the home automation device using the second application profile.

12. The device of claim 1, wherein said local network communications module includes a first radio configured to communicate with the smartmeter using the first application profile, and a second radio configured to communicate with the home automation device using the second application profile.

13. The device of claim 1, wherein said modules collectively include at least three radio transceivers.

14. (canceled)

15. The device of claim 13, wherein said at least three radio transceivers are each configured to communicate using a different a communications specification based on an IEEE communications standard.

16-17. (canceled)

18. The device of claim 1, wherein said microcontroller of said device is configured to operate said local network communications module using both the first application profile and the second application profile concurrently.

19. The device of claim 1, wherein said radio transceiver of said local network communications module is configured to operate a different personal area network for each application profile.

20. The device of claim 12, wherein said radio transceiver of said local network communications module is configured to operate a different personal area network for each application profile.

21. The device claim 1, wherein said microcontroller is configured to sequence radio transmissions transmitted from said wireless communications module and/or said local network communications module.

22. A method for accessing, with a personal controller, a home automation device and an electricity management unit configured to at least measure power flow, the method comprising:
receiving, at an access administrator device at or near an electricity management unit, a command from the personal controller to access at least one of the home automation device and the electricity management unit, the command being received by the access administrator device using a first communications standard;
determining, with the access administrator device, whether the command sent from the personal controller is intended for the home automation device or the electricity management unit; and
sending a local command, with the access administrator device, to the electricity management unit using a wireless personal area network, the local command being sent using a first application profile if the command from the personal controller is determined to be intended for the electricity management unit, otherwise sending the local command, with the access administrator device, to the home automation device using a second application profile different from the first application profile if the command from the personal controller is determined to be intended for the home automation device.

23-26. (canceled)

27. The method of claim 22, further comprising identifying a device or system whose power flow is being measured by the electricity management unit, and sending a command, with the access administrator device, to the electricity management unit to vary the power flow to the device or system identified.

28. The method of claim 22, wherein the electricity management unit is a smartmeter.

29. The method of claim 22, wherein the home automation device includes a power control unit, further comprising varying power from a mains power connection to an electrical device or system connected to the power control unit.

30. The method of claim 22, further comprising reporting energy usage data to the personal controller without storing the energy usage data in the access administrator device.

31. The method of claim 22, further comprising sequencing radio transmissions originating from the access administrator device.

32. A system for controlling a network of home automation devices based on energy usage measured by a smartmeter, the system comprising:
an access administrator including a dual-mode, wireless communications module having at least one radio configured to communicate with a smartphone, the access administrator including a local communications module including at least one ZigBee radio configured to communicate with the network of home automation devices; and
a computer processor configured to operate a cloud-based platform, said processor being configured to receive data from said access administrator and/or the smartphone, said platform processor being configured to communicate data with a processor controlled by an entity without using the smartmeter as an intermediary device between said platform processor and the processor controlled by the entity.

33. The system of claim 32, wherein said platform processor is configured to retrieve an encrypted security key to access the smartmeter and send the key to said access administrator.
